(19) United States
(12) Patent Application Publication
(10) Pub. No.: US 2016/0086113 A1
(43) Pub. Date: Mar. 24, 2016

(54) METHOD AND APPARATUS FOR CROWD SOURCED BUSINESS OPPORTUNITY REALIZATION

(71) Applicants: Jeffrey Scott McBroom, Redmond, WA (US); Luc Metivier, Hamala (FR); Patrick Miquel, Le Plessis Vouchers (FR)

(72) Inventors: Jeffrey Scott McBroom, Redmond, WA (US); Luc Metivier, Hamala (FR); Patrick Miquel, Le Plessis Vouchers (FR)

(21) Appl. No.: 14/495,456

(22) Filed: Sep. 24, 2014

(51) Int. Cl. G06Q 10/06; G06Q 30/02

(52) U.S. Cl. CPC G06Q 10/0637; G06Q 30/0206

(57) ABSTRACT

A computer-implemented technique includes, in a first aspect, a computer-implemented method for crowd sourced realization of a business opportunity. The method includes: facilitating an online discussion of the business opportunity between a registered service requestor and a first registered service provider; receiving a presentation of the business opportunity; evaluating the received business opportunity for realization relative to a plurality of registered service providers; assigning the evaluated business opportunity to at least one of the registered service providers pursuant to the outcome of the evaluation; imposing a pricing system on the presentation, evaluation, and assignment of the business opportunity; wherein the receiving, evaluating, and assigning are performed by a processor. In a second aspect, a computing apparatus is programmed to perform the method. In a third aspect, a non-transitory storage medium is encoded with instructions that, when executed by a computing apparatus, perform the method.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

This section introduces information about and/or from the art that may provide context for or be related to the subject matter described herein and/or claimed below. It provides background information to facilitate a better understanding of the various aspects of what is claimed below. This is therefore a discussion of “related” art. That such art is “related” in no way implies that it is also “prior” art. The related art may or may not be prior art. The discussion in this section of this document is to be read in this light, and not as admissions of prior art.

One of the most vexing problems for any human endeavor is the problem of a resource mismatch. Many times someone will have a good idea but lacks the knowledge, skill, resources, or connections to develop and/or realize the potential of that idea. Conversely, it sometimes happens that someone has a problem or a need for which they would like a good solution while lacking the knowledge, skills, or resources to develop that solution. These types of mismatches create economic efficiencies hampering the realization of numerous business opportunities.

The presently disclosed technique is directed to resolving, or at least reducing, one or all of the problems mentioned above. The inefficiencies mentioned above have been recognized and various approaches have been tried to address them. However, even if solutions are available to the art to address these issues, the art is always receptive to improvements or alternative means, methods and configurations. Thus, there exists and need for technique such as that disclosed herein.

### SUMMARY

In a first aspect, a computer-implemented method for crowd sourced realization of a business opportunity, comprising: facilitating an online discussion of the business opportunity between a registered service requestor and a first registered service provider; receiving a presentation of the business opportunity; evaluating the received business opportunity for realization relative to a plurality of registered service providers; assigning the evaluated business opportunity to at least one of the registered service providers pursuant to the outcome of the evaluation; imposing a pricing system on the presentation, evaluation, and assignment of the business opportunity; wherein the receiving, evaluating, and assigning are performed by a processor.

In a second aspect, a computing apparatus is programmed to perform the method.

In a third aspect, a non-transitory storage medium is encoded with instructions that, when executed by a computing apparatus, perform the method.

The above presents a simplified summary of the invention in order to provide a basic understanding of some aspects of the subject matter disclosed and claimed below. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

### BRIEF DESCRIPTION OF THE DRAWINGS

The invention may be understood by reference to the following description taken in conjunction with the accompanying drawings, in which like reference numerals identify like elements, and in which:

FIG. 1 illustrates the method of the disclosed technique as may be practiced in some aspects of the disclosed technique that facilitates the commercial realization of a business opportunity.

FIG. 2 conceptually depicts selected portions of the hardware and software architecture of a computing apparatus such as may be employed in some aspects of the presently disclosed technique.

FIG. 3 illustrates one particular embodiment of the method in FIG. 1 in which the business opportunity is an idea to be realized—that is, to be developed for commercialization.

FIG. 4 illustrates one particular embodiment of the method in FIG. 1 in which the business opportunity is a problem that is to be resolved.

FIG. 5 conceptually depicts selected portions of the hardware and software architecture of one particular exchange platform such as may be used to implement the one particular embodiment of the process disclosed and claimed below.

FIG. 6 illustrates in one particular embodiment the process of the particular embodiment whose exchange platform is shown in FIG. 3 at a high level.

FIG. 7A-FIG. 7B flow chart the access initiation in the process flow of FIG. 6 in greater detail.

FIG. 8A-FIG. 8I flow chart the idea realization in the process flow of FIG. 6.

FIG. 9A-FIG. 9C flow chart the problem resolution in the process flow of FIG. 6.

FIG. 10A-FIG. 10B flow chart one particular preemption in the process flow of FIG. 6.

FIG. 11A-FIG. 11B flow chart a second particular preemption in the process flow of FIG. 6.

FIG. 12 flow charts a third particular preemption in the process flow of FIG. 6.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments of the subject matter claimed below will now be disclosed. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of

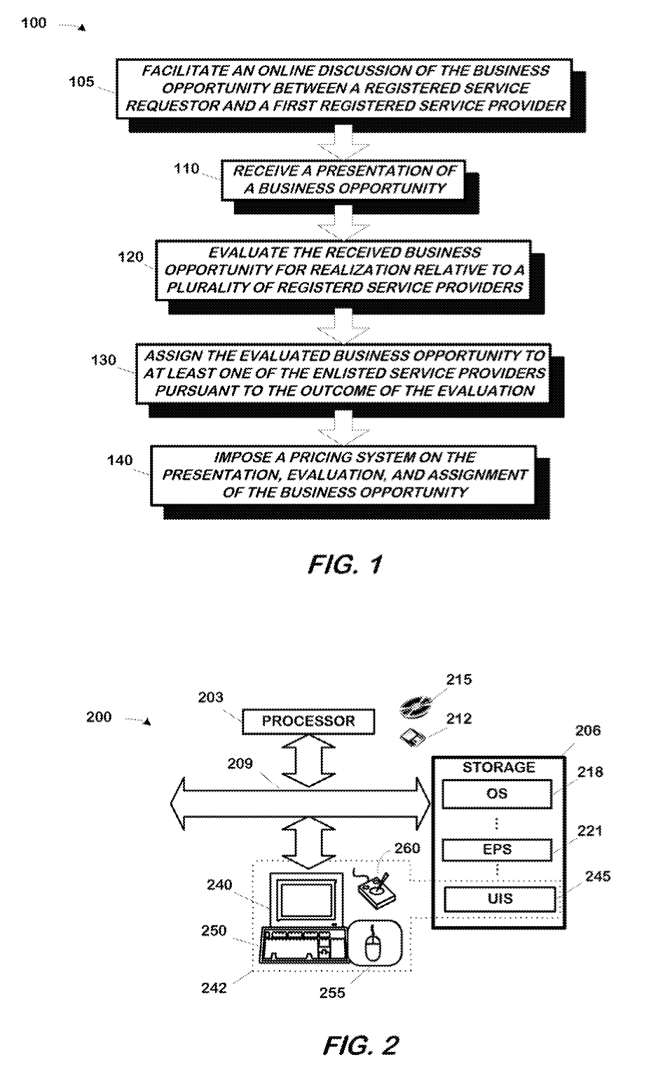

FIG. 1 illustrates the method 100 of the disclosed technique as may be practiced in some aspects of the disclosed technique. The technique begins by facilitating (at 105) an online discussion of the business opportunity between a registered service requestor and a first registered service provider. Facilitating the online discussion may be in the form of, for example, hosting and maintaining an online blog on which the registered service provider and the registered service requestor can post messages responsive to one another. Or, instead of a blog, it might be an interactive chat session, for example. Those skilled in the art having the benefit of this disclosure will appreciate still other variations in which this may be implemented. The online discussion may be private and closed off to other service requestors and service providers or may be opened to all participants of the exchange depending on the embodiment.

The method 100 then continues by receiving (at 110) a presentation of the business opportunity. For best results, the business opportunity should be one that is amenable to resolution through an online collaborative process. It may be, for example, an idea that someone may need help developing for commercialization. Or, it may be a problem that someone has in a business that needs resolution. Those in the art having the benefit of this disclosure will appreciate that there may be other, equally suitable, exemplary types of business opportunities that may be treated in still other embodiments.

The method 100 then evaluates (at 120) the received business opportunity for realization relative to a plurality of registered Service Providers. One objective of the technique is to place people who have a business opportunity, who we may call “Service Requestors”, in collaboration with one or more people who can help them realize that opportunity, who we may call “Service Providers”. The typical embodiment will have a number of Service Providers previously identified that are willing to assist and have some degree of expertise in one or more subject matters. The technique contemplates selecting one or more Service Requestors for participation in the realization of a given business opportunity depending upon the evaluation.

The evaluation itself may take many forms. Such an evaluation might consider objective indicators of the Service Requestor's willingness to assist, such as the amount of their financial commitment to the realization, or their credentials with respect to selected subject matters. Still an evaluation may also consider subjective factors such as ratings from previous interactions or previous real-world experience. Still other embodiments may use still other factors in this evaluation. Note that this evaluation, at least in this particular embodiment, will also consider the subject and nature of the business opportunity being presented. For example, a Service Requestor with some expertise in a first field may be unlikely to provide effective assistance with respect to a business opportunity in a second, unrelated field.

The method 100 then assigns (at 130) the evaluated business opportunity to at least one of the registered Service Providers pursuant to the outcome of the evaluation. Some embodiments might actually assign to more than one registered Service Providers. The assignment will typically result from a “best match” or the “best set of matches” in the evaluation process. Most embodiments will also provide both the Service Requestor and the Service Provider the opportunity to help define the conditions of their collaboration. Typically, this includes the ability to choose who they collaborate with and the financial relationship between them.

The method also imposes (at 140) a pricing system on the presentation, evaluation, and assignment of the business opportunity. This may take many guises depending upon the embodiment. For example, both the Service Requestor and the Service Provider can be required to purchase a “participation package” for access to the technique. For example, a Service Requestor may purchase a participation package that permits them to present a certain number of business opportunities to Service Providers. Conversely, a Service Provider may similarly purchase a package permitting them to participation in the realization of a set number of business opportunities. The packages may also be more sophisticated. For example, a package for a Service Provider might also include opportunities for advertising directed to Service Requestors. Or the package might require the deposit of a certain amount of money for use in transactions with others in the context of the method.

However, other forms of pricing may be included. For example, some embodiments may provide for financial transactions between Service Requestors and Service Providers. These embodiments may impose a commission or a margin on such transactions. For example, some embodiments may permit Service Requestors to accept payment from Service Providers for their participation with respect to a given

The method 100 illustrated in FIG. 1 is computer-implemented, and is performed by an Exchange Platform 200, shown in FIG. 2. The Exchange Platform 200 comprises a computing apparatus coupled with a software element with which the computer is programmed with the functionality of the exchange platform. FIG. 2 conceptually depicts selected portions of the hardware and software architecture of the Exchange Platform 200 such as may be employed in some aspects of the present invention. The Exchange Platform 200 includes at least an electronic processor 203 communicating with storage 206 over a communication medium 209 on the hardware side.

The electronic processor 203 may be any suitable electronic processor or electronic processor set known to the art. Those in the art will appreciate that some types of electronic processors will be preferred in various embodiments depending on familiar implementation-specific details. Factors such as processing power, speed, cost, and power consumption are commonly encountered in the design process and will be highly implementation specific. Because of their ubiquity in the art, such factors will be easily reconciled by those skilled in the art having the benefit of this disclosure. The electronic processor 203 may theoretically be an electronic micro-controller, an electronic controller, an electronic microelectronic processor, an electronic processor set, or an appropriately programmed application specific integrated circuit (“ASIC”), field programmable gate array (“FPGA”), or graphical processing units (“GPUs”). Some embodiments may even use some combination of these electronic processor types.

Those in the art will also appreciate that some embodiments may see high levels of usage such that load balancing techniques may be desirable. Typical implementations for the electronic processor 203 therefore actually constitute multiple electronic processor sets spread across multiple computing apparatuses working in concert. One such embodiment is discussed below. These considerations affect the implementation of the storage 206 and the communication medium 209 similarly.

The storage 206 may include non-transitory storage media such as a magnetic hard disk and/or random access memory (“RAM”) and/or removable storage such as a floppy magnetic disk 212 and an optical disk 215. The storage 206 is encoded with a number of software components. These components include an operating system (“OS”) 218; the exchange platform software (“EPS”) 221; and various data structures. The storage 206 may be distributed across multiple computing apparatuses as described above.

As with the electronic processor 203, implementation-specific design constraints may influence the design of the storage 206 in any particular embodiment. For example, as noted above, the disclosed technique operates on voluminous data sets which will typically mitigate for various types of “mass” storage such as a redundant array of independent disks (“RAID”). Other types of mass storage are known to the art and may also be used in addition to or in lieu of a RAID. As with the electronic processor 203, these kinds of factors are commonplace in the design process and those skilled in the art having the benefit of this disclosure will be able to readily balance them in light of their implementation specific design constraints.

The electronic processor 203 operates under the control of the OS 218 and executes the EPS 221 over the communication medium 209. This process may be initiated automatically, for example upon startup, or upon user command. User command may be directly through a user interface. To that end, the computing system 200 of the illustrated embodiment also employs a user interface 242.

The user interface 242 includes user interface software (“UIS”) 245 and a display 240. It may also include peripheral input/output (“I/O”) devices such as a keypad or keyboard 250, a mouse 255, or a joystick 260. These will be implementation-specific details that are not germane to the presently disclosed technique. For example, some embodiments may forego peripheral I/O devices if the display 240 includes a touch screen. Accordingly, the presently disclosed technique admits wide variation in this aspect of the computing system 200 and any conventional implementation known to the art may be used.

The EPS 221 may be implemented in any kind of software component, such as an application, a daemon, or a utility. The functionality of the EPS 221 need not be aggregated into a single software component and may be distributed across two or more software components. Typically, the EPS 221 will be a set of multiple, interrelated software components functioning in concert. Similarly, the data structures may be implemented using any suitable data structure known to the art.

As with the electronic processor 203 and the storage 206, the implementation of the communications medium 209 will vary with the implementation. If the computing system 200 is deployed on a single computing apparatus, the communications medium 209 may be, for example, the bus system of that single computing apparatus. Or, if the computing system 200 is implemented across a plurality of networked computing apparatuses, then the communications medium 209 may include a wired or wireless link between the computing apparatuses. Thus, the implementation of the communications medium 209 will be highly dependent on the particular embodiment in ways that will be apparent to those skilled in the art having the benefit of this disclosure.

As is apparent from the description herein, some portions of the detailed descriptions herein are presented in terms of a software implemented process involving symbolic representations of operations on data bits within a memory in a computing system or a computing device. These descriptions and representations are the means used by those in the art to most effectively convey the substance of their work to others skilled in the art. The process and operation require physical manipulations of physical quantities that will physically transform the particular machine or system on which the manipulations are performed or on which the results are stored. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

Furthermore, the execution of the software's functionality transforms the computing apparatus on which it is performed. For example, acquisition of data will physically alter the content of the storage, as will subsequent processing of that data. The physical alteration is a “physical transformation” in that it changes the physical state of the storage for the computing apparatus.

Note also that the software implemented aspects of the invention are typically encoded on some form of program storage medium or, alternatively, implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The business opportunity to be realized may vary quite widely. As mentioned above, the person who presents the business opportunity may be generally referred to as the “Service Requestor” since they are requesting the services of the Exchange Platform 200 and those associated with it in the realization of that business opportunity. The people who provide services in the realization of the business opportunity through the Exchange Platform 200 may therefore be referred to as “Service Providers”, also as mentioned above. The nature of the services procured through the exchange platform will vary depending on the nature of the business opportunity presented.

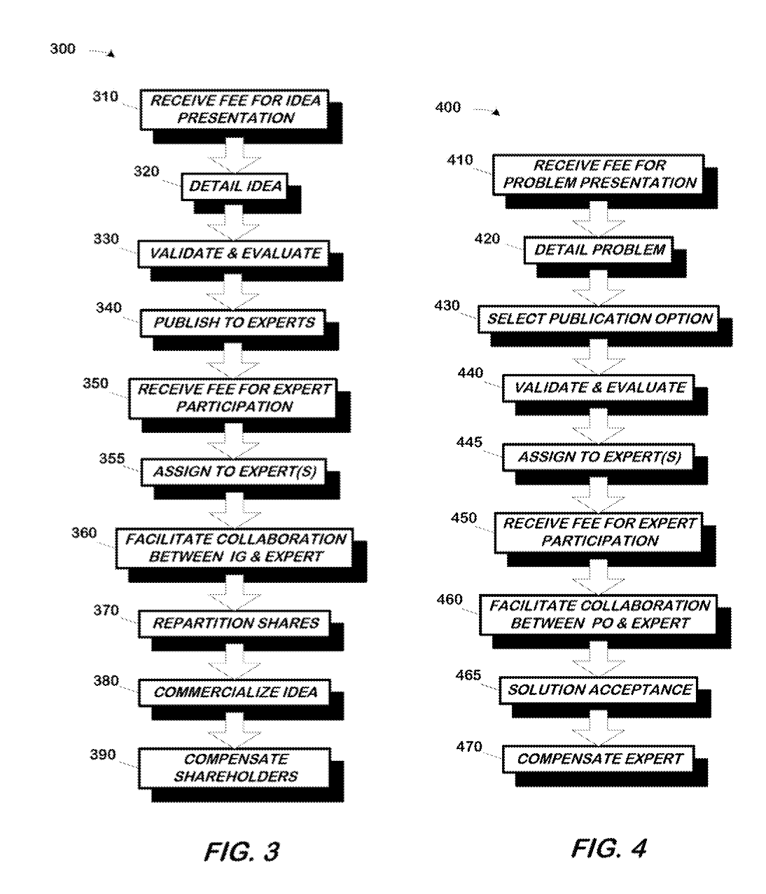

Consider the embodiment represented by the method 300 of FIG. 3. in this particular embodiment, the business opportunity is an Idea that the Service Requestor wishes to develop for marketing and commercialization. The Service Requestor in this embodiment therefore may be referred to as the “Idea Generator”, or “IG”. The Idea Generator will pay a fee to the Exchange Platform 200 for the opportunity to present the Idea to the Experts of the exchange platforms. The Service Providers are selected on the basis of their expertise as it may relate to the development of the Idea, and so may be called “Experts”. The Experts also pay a fee for the opportunity to participate in the development of the Idea.

The method 300 begins with the receipt (at 310) of the Idea Generator's fee for the presentation of the Idea. Once the Idea Generator provides the fee, they then begin detailing (at 320) the Idea to the Exchange Platform 200. The Exchange Platform 200 may provide prompts or questions to help guide the disclosure. Some embodiments may not only permit, but encourage the Idea Generator to upload already completed documents, if available. For example, functional specifications, materials requirements, machine drawings will all help create a stronger definition of the Idea and help attract greater participation from experts.

The Exchange Platform 200 then validates and evaluates (at 330) the Idea. This may be a qualitative or an objective assessment and will typically be performed by an employee or operator of the Exchange Platform 200. The purpose is to ensure that the Idea is feasible and presented with enough specification to make it worthwhile to present it to the Experts. To this end, the fuller and more detailed the disclosure is when the Idea is detailed, the more likely it is to receive a successful validation and evaluation. Some embodiments may also provide the Idea Generator an opportunity to modify the original disclosure of the Idea to provide additional definition and then return to the validation and evaluation (at 330).

Upon validation and evaluation (at 330), the Idea is then published (at 340) to the Experts. Each of the Experts in this particular embodiment has paid a fee for the opportunity to participate in the development of such an Idea. Upon publication, the Experts can determine whether to exercise their paid opportunity on the particular Idea being published (at 340). Thus, by this point, the Exchange Platform 200 has received (at 350) the Experts' fee(s) for participating in the Exchange Platform 200.

Note that typically the Idea Generator's fee (310) and the Expert's fee (at 350) will have previously been paid. It is envisioned that Idea Generators and Experts will actually purchase access in “packages” that permit, for example, the presentation of a certain number ideas or the participation in the development of a certain number of ideas presented by someone else. The way these opportunities are determined can vary across embodiments. For example, every time the Idea Generator details an Idea (at 320), that might count as a “presentation” that counts against the purchased number of opportunities. Other embodiments might only count ideas that are successfully validated and evaluated (at 330). The receipt of the fees (at 310, 350) is not necessarily tied temporally to the participation at any particular point in the Exchange Platform 200 other than such payment will typically precede participation. Some embodiments may also provide participants the ability to modify their packages should they wish for an opportunity beyond what they have previously purchased.

Still referring to FIG. 3, the Exchange Platform 200 then assigns (at 35) the idea to one or more experts for development and facilitates (at 360) collaboration between the Idea Generator and one or more Experts. This collaboration (at 360) may take many forms. In some embodiments, this may include invoking such functionalities as videoconferencing or chat. In one embodiment discussed further below, the Exchange Platform 200 establishes a closed virtual room that permits the Idea Generator and the Expert to securely and confidentially discuss and develop the Idea. This aspect of the process may take many forms and is directed at getting the Idea in a “final” form, or to a stage in which it is sufficiently developed for commercialization.

One form of compensation in this particular embodiment is the notion of “shares” in the Idea. When the Idea is first presented (at 310, 320, 330, 340), the Idea. Generator is assigned 100% of the shares. “Shares” in the idea represent a level of investment in the idea. If the Idea

Generator and the Expert are able to “finalize” the Idea or get it sufficiently developed for marketing, the shares are reapportioned (at 370). The repartition can be tied objectively or subjectively to the Expert's performance and the Idea Generator's satisfaction. Or, for example, it can just become a 50/50 split in ownership because two people participated. The manner in which the shares are repartitioned is not material to the practice of the invention and may be omitted in some embodiments.

Once the Idea is “finalized”, it is then commercialized (at 380). Those in the art having the benefit of this disclosure will appreciate that the manner in which such commercialization occurs will depend significantly on the nature of the Idea. Some Ideas may be commercialized online while others may require activities offline and away from the Exchange Platform 200. Thus, not all aspects of the disclosed technique are necessarily performed online. However commercialization happens, it then follows that the shareholders are compensated (at 390).

Now referring to both FIG. 1 and FIG. 3, the Exchange Platform 200 receives the presentation of the business opportunity (at 110) in this particular embodiment through the detailing of the idea (at 320). The evaluation (at 120) occurs in several parts of the embodiment 300, including the validation and evaluation of the idea (at 330), publication to the experts (at 340), and the receipt of the fee (at 350). One embodiment illustrating how this might be implemented is disclosed in further detail below. The assignment for realization (at 130) occurs the assignment (at 355) and collaboration facilitation (at 360). And, finally, the pricing system (at 140) in this particular embodiment is manifested in several place, including the fee for the idea presentation (at 310), the fee for the expert participation (at 350), the repartition of the shares (at 370), and the compensation of the shareholders (at 390).

The embodiment 300 is but one potential embodiment, however. FIG. 4 presents another potential embodiment 400 in which the presented business opportunity is a problem for which the submitter seeks a solution. The Service Requestor, or “submitter”, in this embodiment may be referred to as the “Problem Owner”, or “PO”. In this embodiment, too, the Problem Owner and the Expert will pay a fee for participation. Like the embodiment of FIG. 3, these fees will typically be in the form of a purchase price for a participation package as is discussed above. This embodiment also provides for additional transactions between the Problem Owner and the Expert as will be discussed further below.

As with the embodiment 300 in FIG. 3, the embodiment 400 in FIG. 4 begins with receipt (at 410) of a fee for the Problem Owner's participation after which the problem is detailed (at 420). As in the embodiment of FIG. 3, the Problem Owner is encouraged to submit as full a disclosure of the problem as they can. This includes uploading documents, pictures, machine drawings, and whatever other material the Problem Owner possesses that might help explain the problem and delineate its scope. The disclosure of the problem and the problem itself are then evaluated and validated (at 440) as suitable for Expert participation.

The Expert is the selected (at 445). Upon receiving (at 450) the Expert's fee for participation, the Exchange Platform 200 facilitates (at 460) between the Problem Owner and the Expert. Like the same act in the embodiment of FIG. 3, this may take many forms and is directed to “finalizing” a solution to the Problem. Note that the Expert's participation is conditioned not only on their paying (at 450) a fee, but also agreement between the Problem Owner and the Expert as to compensation for the successful development of a solution to the Problem. Once the solution is “finalized” or “accepted) (at 465), then the Expert is compensated (at 470) in a manner previously agreed upon.

Referring now to both FIG. 1 and FIG. 4, the receipt of the presentation of the business opportunity (at 110) is found in the detailing of the problem (at 420). The evaluation (at 120) comes in the form of the publication option selection (430) and the validation and evaluation (at 440). The assignment to the expert(s) (at 130) manifests as the expert selection (at 445) and the collaboration facilitation (at 460). And, finally, the pricing system imposition (at 140) is implemented as the problem presentation fee (at 410), the expert participation fee (at 450), and the expert compensation (at 470).

In the embodiments illustrated herein, the Exchange Platform 200 uses a technique referred to as a “bid offer network exchange”, or “BONE”, technique for the management of money. The BONE technique begins with the Service Requestor placing an offer amount as a target and purchase any insurance required (for such services like borrowing tools, package delivery, etc.). The offer amount is the amount of money that the Service Requestor is willing to pay for the prospective services to be rendered in the realization of that business opportunity. Experts will then bid to provide the service. The bids can equal the target offer or go higher/lower than the target offer. The Experts are not only bidding to provide the services, but may also be bidding against other Experts to provide the services. Everyone will have an established rating based on feedback from previous services provided. The ratings are also provided to the Service Requestor along with the bids. The Service Requestor can then choose which Bid to accept based on the bid, the ratings, and the comments for each Expert.

The selected Expert then provides the payment for the bid prices. The money is held in escrow until the Service Requestor establishes that the service specifications for the project have been accomplished in full by the Expert. If the specifications have been accomplished in full then the Service Requestor will so indicate to transfer the funds. If there is a dispute, then the exchange platform will encourage both the Service Requestor and the Expert to look at the specifications and resolve the dispute. In the event resolution cannot be reached, a mediation procedure will be invoked. The specifications are considered in light of any other evidence submitted by the parties. Note that some embodiments may employ an arbitration rather than a mediation for dispute resolution. Once resolution is reached, then the escrowed money is transferred to the Expert.

Those in the art having the benefit of this disclosure will appreciate that various embodiments of the presently disclosed technique can, and typically will, be more complex and detailed than the embodiments set forth above. The complexity may be realized in the hardware architecture, the software architecture, and the functionality of the exchange platform as a whole. To further an understanding of the subject matter claimed below and how it might be more technically implemented one such more complex embodiment shall now be discussed.

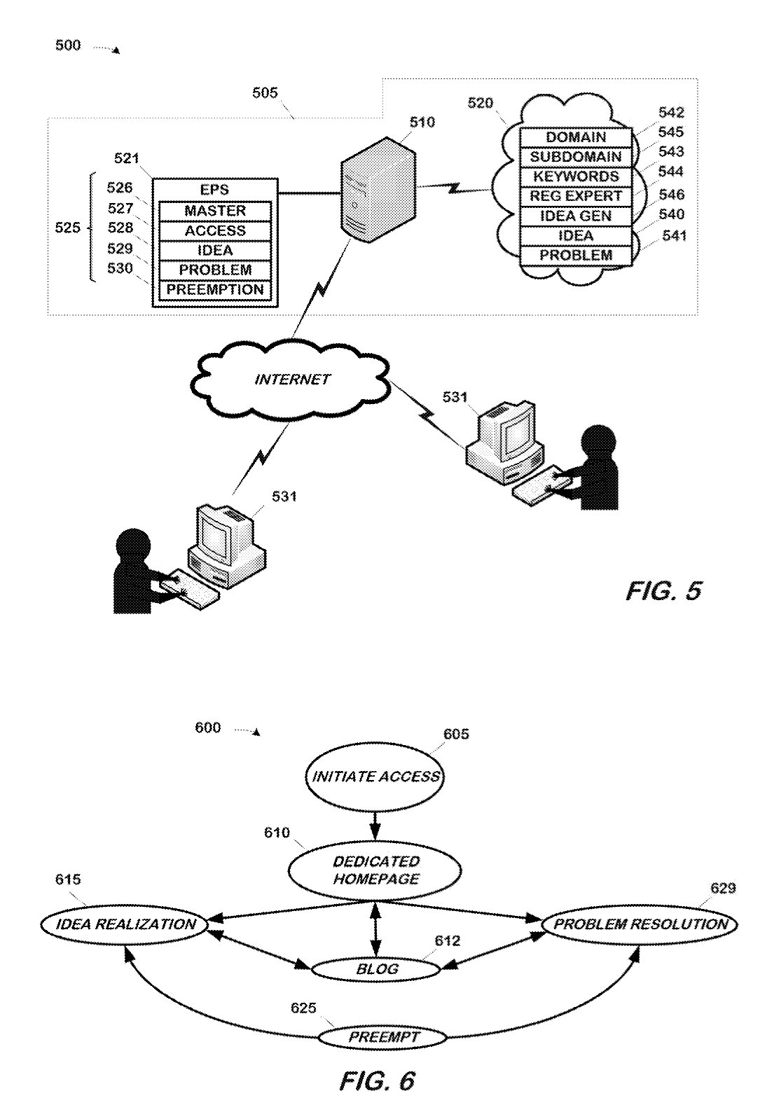

A portion of an exemplary computing system 500 by which such processing occurs in the illustrated embodiment is shown in FIG. 5. The computing system 500 is networked, but there is no requirement that the computing system 500 be networked. Alternative embodiments may employ, for instance, a peer-to-peer architecture or some hybrid of a peer-to-peer and client/server architecture. The size and geographic scope of the computing system 500 is not material to the practice of the invention. The size and scope may range anywhere from just a few machines of a Local Area Network (“LAN”) located in the same room to many hundreds or thousands of machines globally distributed in an enterprise computing system.

The computing system 500 comprises, in the illustrated portion, an exchange platform 505. The exchange platform 505 includes a server 510, and a mass storage device 520, as well as the exchange platform software 521. The mass storage device 520 in this embodiment is actually a cloud such as is known in the art.

Each of the hardware components may be implemented in their hardware in conventional fashion. Alternative embodiments may also vary in the computing apparatuses used to implement the computing system 500. Those in the art will furthermore appreciate that the computing system 500, and even that portion of it that is shown, will be much more complex. However, such detail is conventional and shall not be shown or discussed to avoid obscuring the subject matter claimed below.

In FIG. 5, the EPS 521 is shown residing on the server 510 while the seismic data 500 resides in the mass storage 520. While this is one way to locate the various software components, the technique is not dependent upon such an arrangement. Although performance concerns may mitigate for certain locations in particular embodiments, the situs of the software components is otherwise immaterial. The EPS 521 might, for example, also be stored on the mass storage 520 instead of the server 510.

The EPS 521 is a suite 525 comprised of at least four separate modules. The first module is the master module 526, which provides the interface between a user and the EPS 521. The user then, through the master module 526, invokes the functionality of the access module 527, the Idea module 528, the problem module 529, and the preemption module 530. How the user utilizes the functionality of the EPS 521 will depend on his relationship to the exchange platform 500 as described further below.

A number of data structures containing data off which the EPS 521 operates reside on the mass storage 520. This includes an idea data structure 540, a problem data structure 541, a domain data structure 542, a subdomain data structure 543, a keyword data structure 544, a registered Idea Generator data structure 545, and a registered expert data structure 546. In this particular embodiment, the data structures are all SQL, databases although any suitable data structure known to the art may be used.

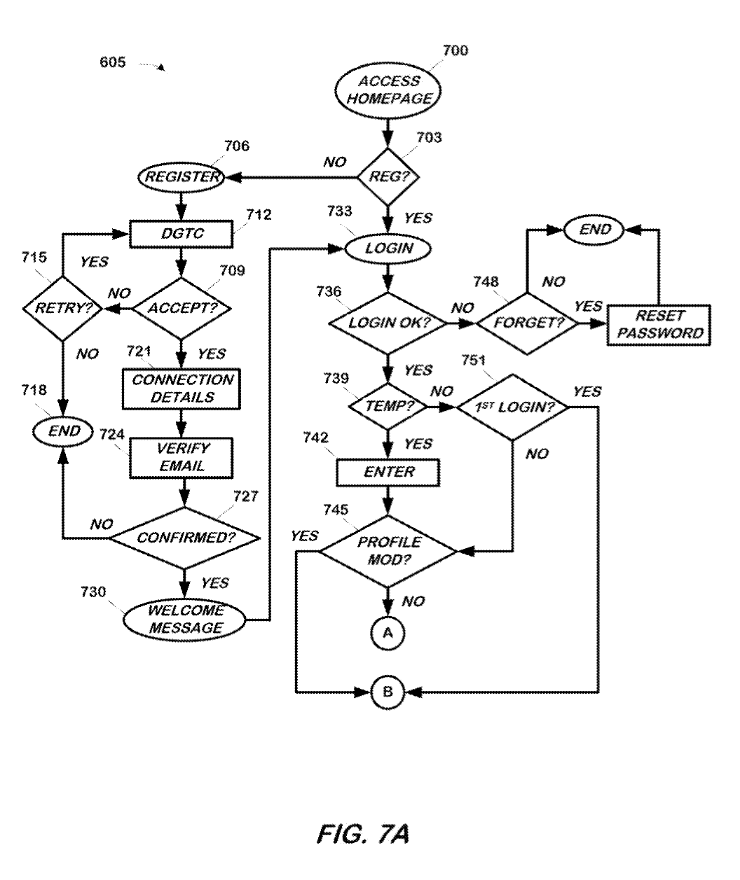

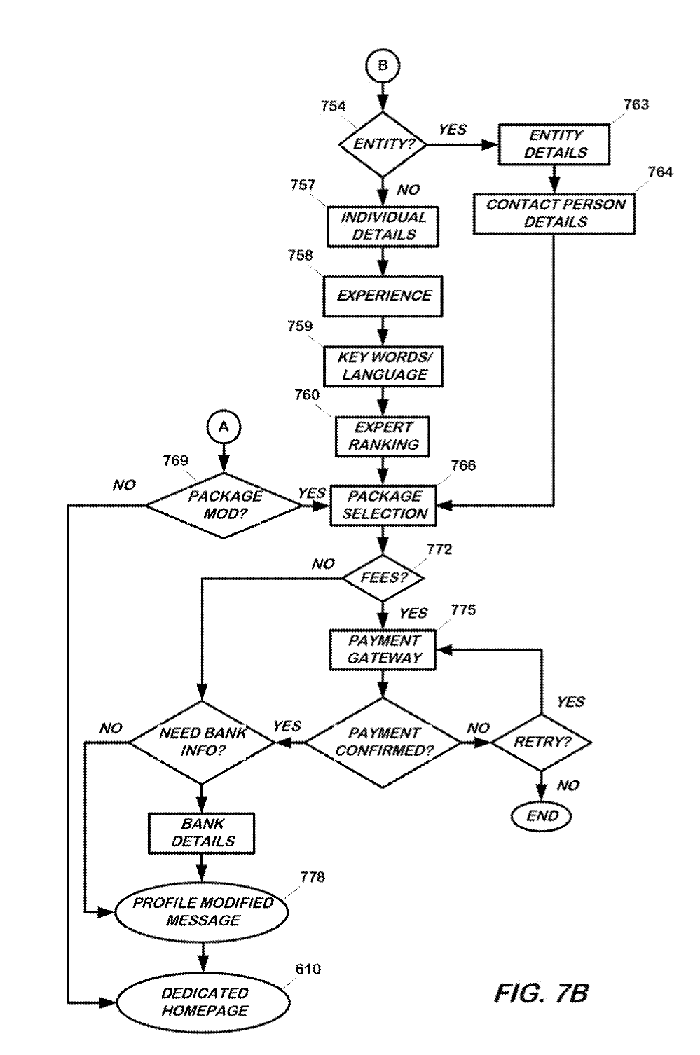

Referring now to FIG. 6, the EPS 521 in this particular embodiment performs the process 600 when invoked. The process 600 begins when a user initiates access (at 605), described further below in connection with FIG. 7A-FIG. 7B. Once access has been properly been established, the user will find themselves (at 610) at their dedicated homepage. The dedicated homepage is a private home page. Every user of the exchange platform, whether an individual or an entity, will have one. The user will be able to access all other functionalities of the exchange platform that are associated with their user type. It may also provide various kinds of communications like a dashboard presenting ongoing activities and their status with a link to display details; links to closed activities and a display their details; recap(s) of payment(s) received or paid with details; and recaps of selected offer and status of included options. Other information may be communicated as well. The dedicated homepage is the jumping off point for the primary functionalities of the exchange platform.

One thing the user can access from the dedicated homepage (at 610) is the exchange blog (at 612). Here, the user may converse with other registered users about a variety of topics, typically from the perspective of the capacity in which they have registered. Some embodiments may employ an interactive chat session in addition to, or in lieu of the exchange blog (at 612). This particular embodiment also provides access to the exchange blog (at 612) from the process flow of the business opportunities discussed further below. The blog exchange (at 612) therefore provides a convenient and fluid communications path for participants using the exchange platform.

One particular aspect of the illustrated embodiment is that direct interactions between registered users are conducted in an anonymous fashion. Registered users may be assigned a user identification or may select a user identification unrelated to their offline identity. These registered user identifications are used in all direct interactions between and among registered users to help prevent them from circumventing the exchange platform and by meeting and realizing the presented business opportunity offline. This is a useful adjunct to policies agreed upon by the users during registration which prohibit such conduct and could lead to sanctions such as a ban from further use of the exchange platform. This may apply to all such interactions including not only the blog exchange (at 612) but also chat sessions and private room discussions as are mentioned elsewhere herein.

The embodiment of FIG. 5-FIG. 6 facilitates the realization of two different kinds of business opportunities—idea realization (at 615) and problem resolution (at 620). Idea exploitation (at 615) will typically involve the introduction of an idea for a new product or service, its refinement for marketing, and marketing. Problem resolution (at 620) will typically involve the resolution of a business oriented problem, such as a logistics problem or a management problem. This particular embodiment also includes a functionality whereby a user may preempt (at 625) the idea realization (at 615) and problem resolution (at 620) functionalities as described further below.

One aspect of this particular embodiment is the imposition of the pricing system. Each user of the Exchange Platform 503 is registered prior to participation. One aspect of registration is the purchase of a participation package. This particular embodiment also permits financial transactions between registered users, such as Service Requestors and Service Providers. For each transaction, the Exchange Platform 503 imposes an Exchange Margin. The Exchange Margin may be whatever the market will bear. Thus, when a registered user proffers a price or monetary amount that is to be conveyed to another registered user, the amount conveyed is the Net Offer Amount. The Net Offer Amount is the amount that the receiving registered user will actually receive and is equal to the amount proffered less the Exchange Margin.

Referring now to both FIG. 5 and FIG. 6, each significant functionality as illustrated in FIG. 6 is performed by a separate module in the EPS 521. That is, access (at 605) is implemented by the access module 527, idea realization (at 615) is implemented by the Idea module 528, the problem resolution (at 620) is implemented by the problem module 529, and the preemption (at 625) is implemented by the preemption module 530. However, alternative embodiments may employ different software architectures. For example, all such functionalities may be implemented in a single application in some embodiments.

Returning now to FIG. 6, access comes in two forms: registration and login. Registration is required for login, but registration need only be performed once. The nature of the registration will depend on the nature of the user that is, whether they are participating as an individual or are representing an entity—as well as the role that user will play in the in the exchange platform.

More particularly, and turning now to FIG. 7A, the user initiates access (at 605) by accessing (at 700) the exchange platform's home page. The home page is publicly accessible just as any other website on the World Wide Web of the Internet in this particular embodiment. New users may register from the home page and registered users may login. It may perform an informational role by presenting the underlying concept and functionalities and details of offered services and Free/Pay participation packages for individuals and entities. It may also perform an advertising role by presenting customer feedback and testimonials, examples of finalized ideas and profits generated through the exchange platform, examples of problems solved and resultant profits generated through the exchange platform, sponsors, etc.

However, relative to the current discussion, it provides a mechanism through which new users may register and registered users may login. The exchange platform first determines (at 703) whether the user is registered and if not, proceeds to registration (at 706). Registration (at 706) requires acceptance (at 709) of the disclaimers and general terms and conditions (“DGTC”) (at 712). These may include disclaimers of liability, terms and conditions of participation, and policies regarding intellectual property and confidentiality. Failure to accept (at 709) the disclaimers and general terms and conditions (at 712) upon retry (at 715) ends (at 718) the registration process, which also ends participation in the exchange platform.

Acceptance (at 709) of the disclaimers and general terms and conditions (at 712) then leads to the registration process. It provides the opportunity to provide information regarding registration such as the advantages of registration and the description of the different available participation packages and their respective benefits. It may also include other information such as, for example, a more detailed presentation of the way intellectual property is managed. It does include conventional registration aspects (at 721) such as User ID assignment, electronic email contact address, password, and Captcha verification. Relative to the subject matter claimed below, the user must declare registration as an individual or an entity. Upon verification (at 724) through electronic mail, registration is confirmed (at 727) and the user notified through a welcome message (at 730).

Upon registration (at 730), or upon access if previously registered (at 703), the user may login (at 733). If the login is correct (736), the exchange platform determines (at 739) whether the password is temporary and, if so, whether the user needs to set a new password (at 742) and modify their profile (at 745). If the login is incorrect, then provisions are made (at 748) for password recovery. User ID recovery and other conventional features addressing incorrect login may also be used in some embodiments.

If the login is correct (at 736) and the password is not temporary (at 739), the exchange platform will determine (at 751) if this is the user's first login. If not, then the exchange platform will determine (at 745) whether the user wishes to modify their profile. If it is a first login (at 751) or the user wishes to modify their profile (at 745), then the exchange platform moves to profile modification/creation.

Turning now to FIG. 7B, profile modification/creation is one of the tools used by the exchange platform to manage and direct the self-organization of registered users. The exchange platform first ascertains (at 754) whether the registered user wishes to set up or modify a profile as an individual or an entity. If an individual, then the exchange platform prompts the user to enter individual details (at 757) such as identifying and contact information. The user then inputs experience (at 758), keywords and language (at 759), and the exchange platform assigns an “expert ranking” (at 760).

The user's experience (at 758) is self-entered and the user enters the number of years of experience in a sub-domain or a domain and a current level or position along with an indication of whether they are actively working in the field. They can self-assign an expertise level and provide a description of their experience and qualifications in a given Domain along with supporting documents, if desired. They can also add new experience, modify or delete existing experience, and promote or demote existing experiences. Thus, the user can submit multiple experiences and, in the illustrated embodiment, as asked to do so in descending order of expertise.

In the embodiments illustrated herein, exchange platform keeps a relationship between each Domain and one or more (typically two) Domains that are “connected”, or “related”. Many times, Experts will have experience in multiple Domains that are technically different but highly related. This multi-Domains specification will help ensure that no Experts will miss the opportunity to contribute to a good Idea.

Keywords (at 759) are a list of words used to qualify the user as an expert across experiences. The user is presented with a list of key words from which to select from the most relevant to the least. It the user feels the list is lacking or deficient, there is a mechanism by which they can enter their own keyword(s). There is also an option to disassociate a previously selected keyword. Language information (at 759) pertains to the user's fluency in a particular language-what the language is, whether they can speak, write, and read it, and whether the language is their first language. The user may also enter which languages in which they are proficient at this point.

The expert ranking (at 760) assigned by the exchange platform will, in this particular embodiment, be one of three. The first is a “domain expert”, or a user having a large experience in one or more domains. The second is an “expert”, or a user having experience in one or multiple domains. The third is a “user”, one who has no experience indicated or is too new for meaningful feedback to have accumulated. The ranking can evolve over time as the use modifies their profile or as feedback is received from the exchange platform's other users. For example, a user involved in a project with a second user may indicate that the second user was a particularly valuable contributor on that project, which might increase that second user's expert ranking.

If the user is representing an entity (at 754), the registration/profile modification proceeds by eliciting the entity's details (at 763) and the contact person's details (at 764). The entity's details primarily comprise identifying information like name, country of incorporation, physical location, domain/subdomain of activity, email address, website, and phone number. Note the inclusion of the domain/subdomain of activity, which is again how the users self-organize The contact person's details (at 764) similarly elicit identifying information such as name, position with the entity, email address, phone number, etc.

Once the data entry is completed, the exchange platform then presents the user with a participation package selection (at 766). A previously registered user may also arrive at this point if they indicate (at 769) that they want to modify their participation package selection. If so, then the exchange platform determines whether a payment is necessary (at 772) and, if so, goes through that process (at 775). The once the monetary arrangements have been addressed adequately, the user is the displayed a message (at 778) and the user is delivered to a dedicated homepage (at 781). A previously registered user can also arrive at the dedicated homepage (at 781) more directly if they do not need to modify their profile (at 745) or participation package (at 769). Thus, referring to both FIG. 6 and FIG. 7B, at the conclusion of initiating access (at 605), the user finds themselves at their dedicated homepage (at 781).

Referring now to FIG. 6, the illustrated embodiment contemplates that one functionality associated with the user's dedicated homepage (at 781) is an idea realization (at 615). That is, the user takes on the role of an “Idea Generator” and presents a business opportunity in the form of an idea for other users, who take on the role of “experts”, to help develop and realize. This implies that the user has a priori selected a participation package (at 766) that permits them to participate in this activity on the exchange platform. Most such participation packages will have a maximum number of idea submissions for a given fee, and so this implies that the user has not met that maximum.

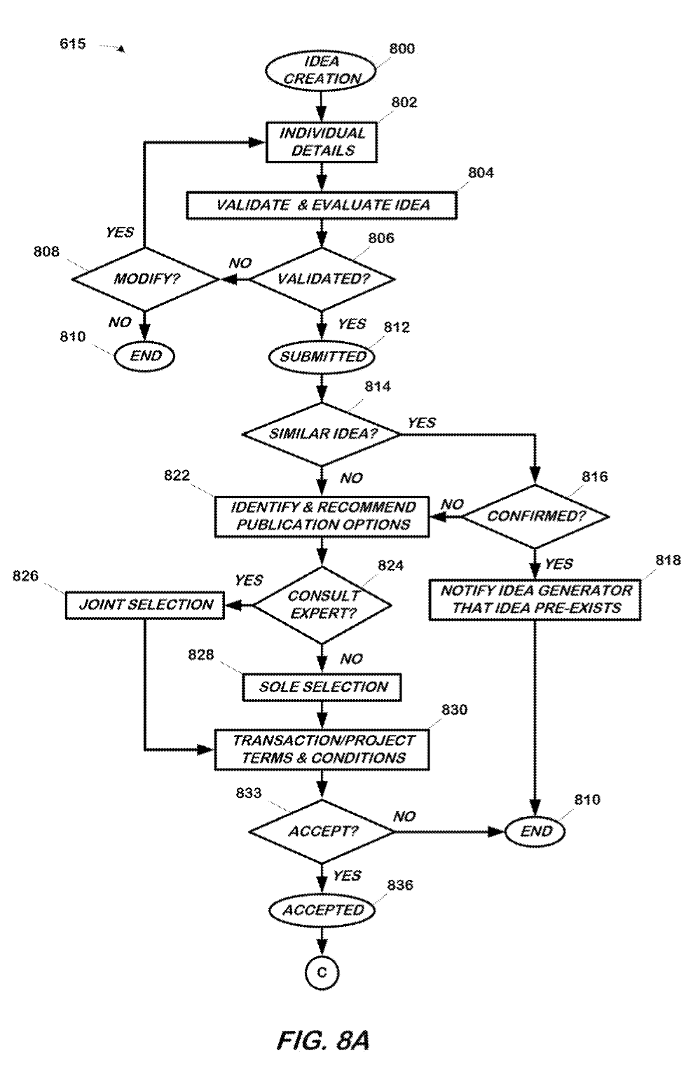

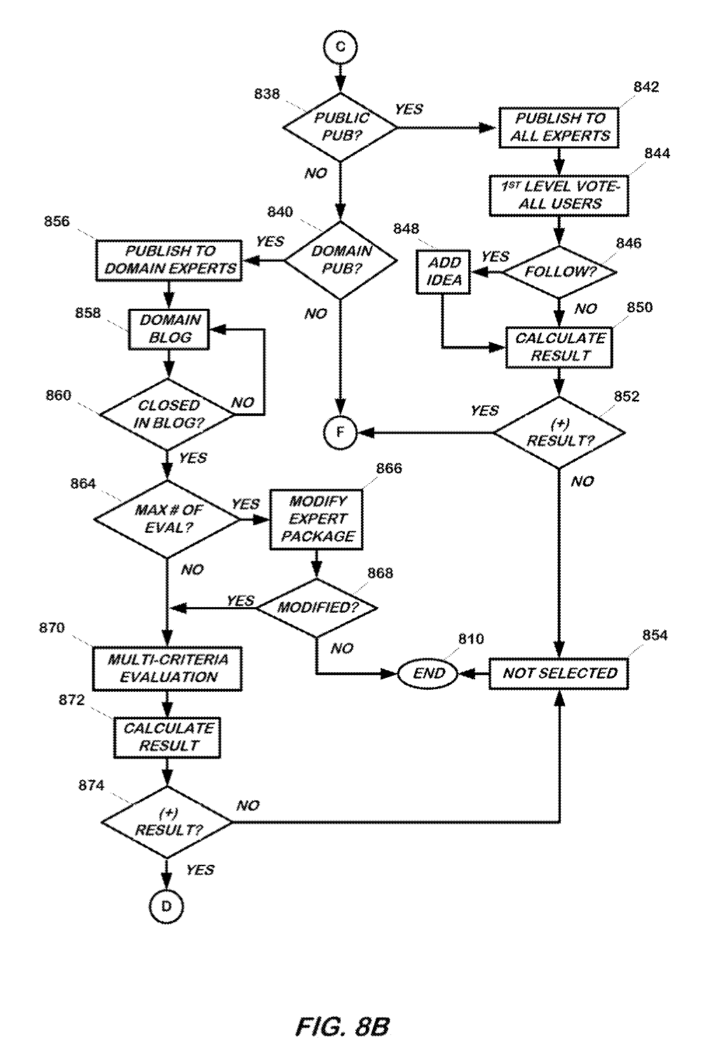

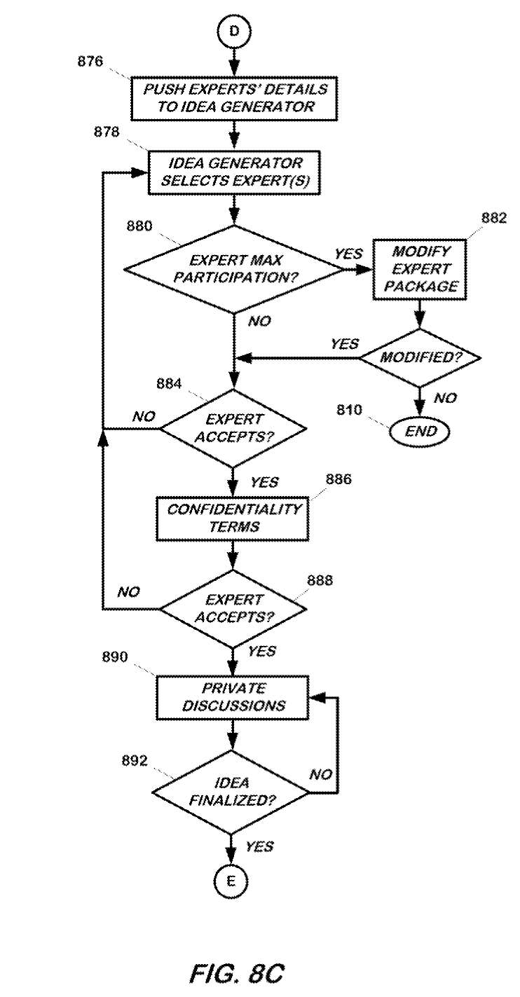

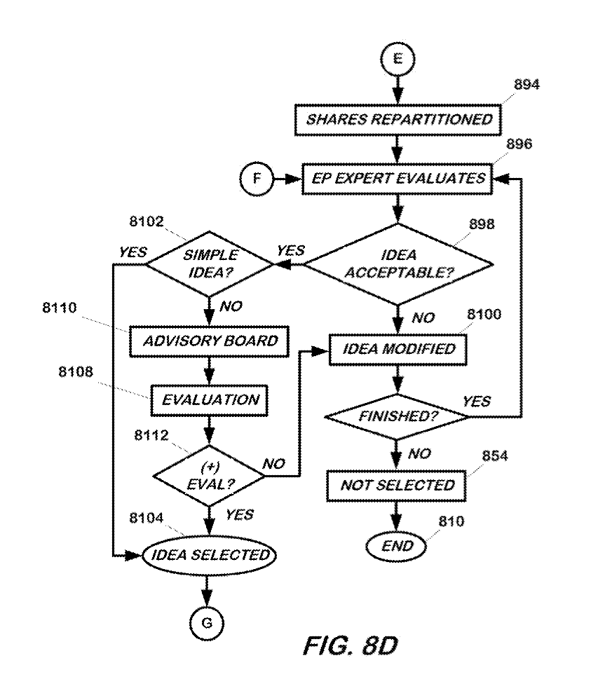

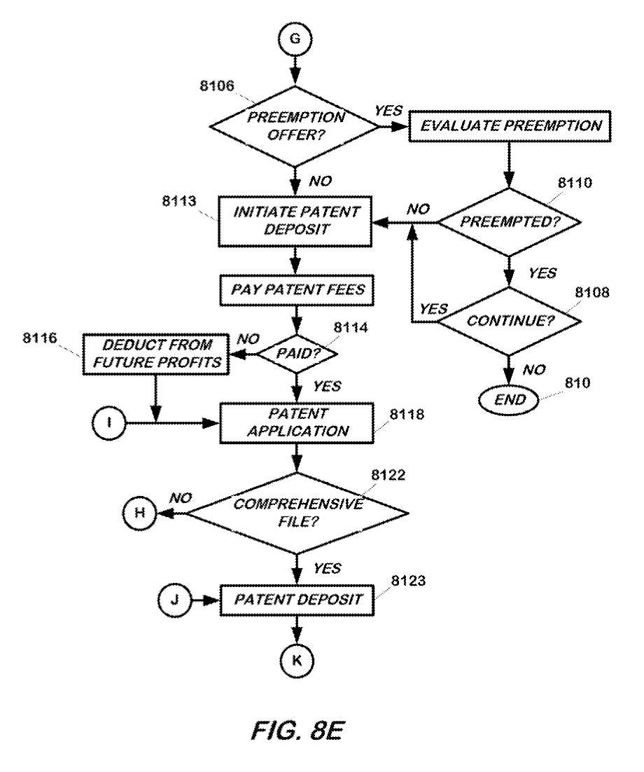

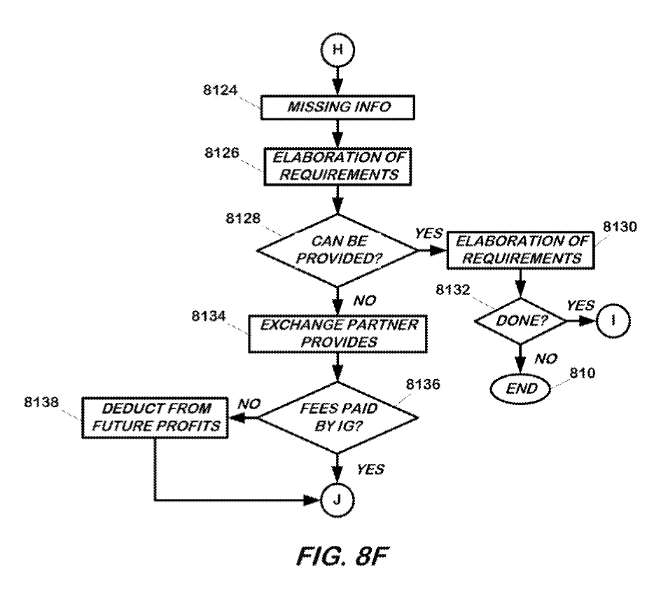

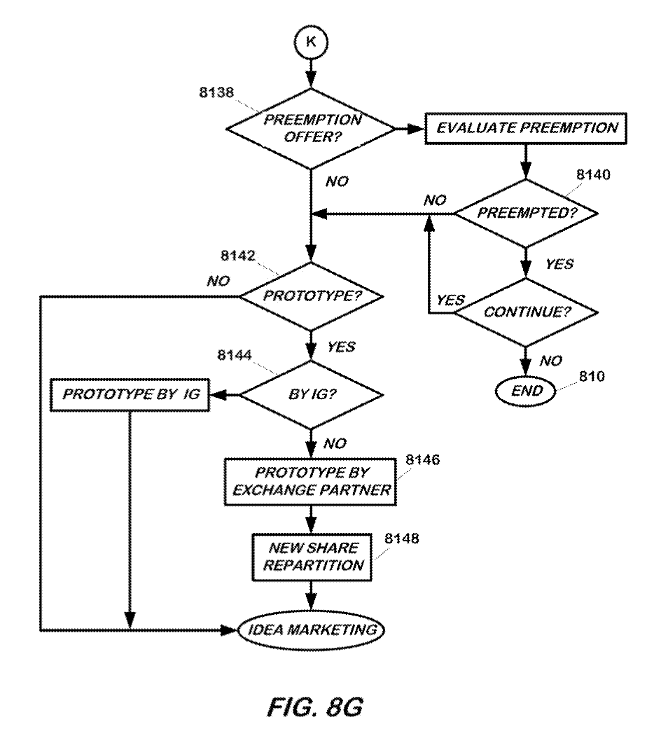

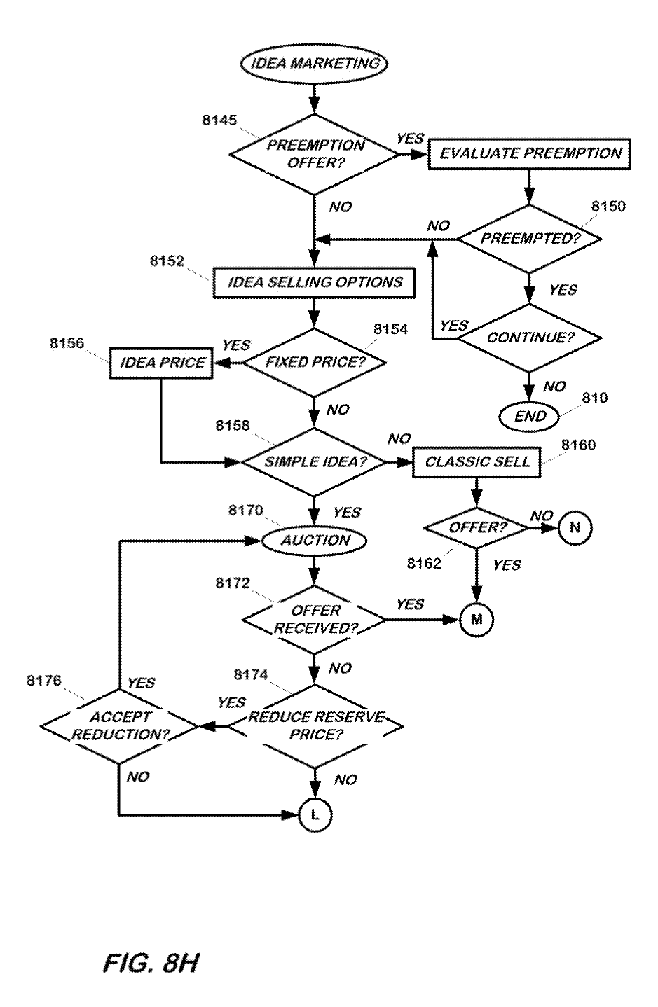

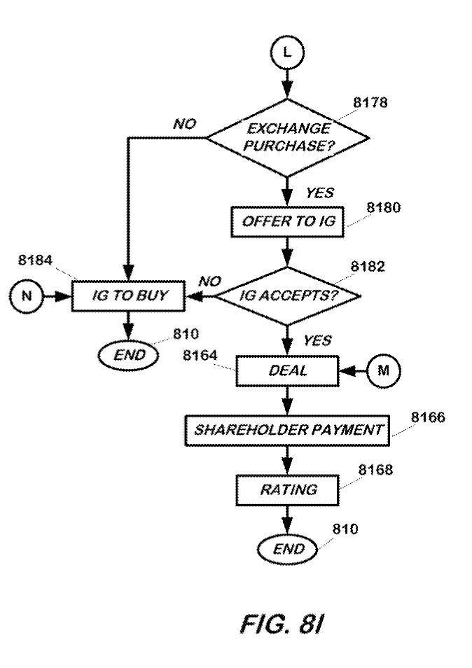

Turning now to FIG. 8A, the idea realization (at 615) begins with the creation of an idea (at 800) by the Idea Generator. The Idea Generator begins by supplying the Idea details (at 802). The idea details include, for example, a name for the Idea, a description of the Idea, the domain and subdomain in which is fits, relevant key words. There also is the opportunity to upload supporting documentation, identify any pertinent intellectual property, and an indication of whether a prototype is desired.

The exchange platform then validates and evaluates (at 804) the proposed idea. In this particular embodiment, this performed by a part of the software suite called the Exchange Platform Engine (EPE). “Validation” in this sense means that the Idea Generator has input all the required information. If the Idea Generator has left out some details, the Idea is not validated (at 806) and the Idea Generator is asked to modify (at 808) the details. If the Idea Generator refuses, the Idea proposal ends at (Z10). If the Idea is validated (at 806), the Idea is considered submitted (at 812). This involves the exchange platform entering the submitted idea into the Idea database, assigning the submitted idea a unique identifier, notifying the Idea Generator of the unique identifier, populating the submitted idea to the Idea Generator's dedicated homepage, and incrementing the count of the Idea Generator's submitted ideas by 1.

The EPE then searches (at 814) idea database for similar, previously submitted ideas. The search is premised on an analysis of the domain, subdomain, keywords and description associated with each submitted idea in the Idea database. With respect to the description, the EPE uses a semantic engine that searches if the descriptions are similar not only word by word, but also the meaning of the sentences.

If the EPE locates (at 814) a similar, previously submitted idea, the newly submitted idea and the previously submitted idea are forwarded to an experts selected by the EPE for confirmation (at 816). The expert may be one of the previously registered experts or one external to the exchange platform's process. If the expert agrees (at 816), the EPE then notifies (at 818) the Idea Generator who submitted and the process ends (at 810) for this particular submitted idea. That is, the submitted idea is not “accepted”. An indication is also made in the Idea database that the Idea has not been accepted. In this particular embodiment, the reviewing expert enters comments and conclusions in a dedicated page kept by the EPE.

If the experts disagrees and finds no similarity (at 816), or if the EPE finds no similar idea (at 814), then the EPE identifies and recommends (at 822) publication options to the Idea Generator. “Publication” in this context does not mean a general publication. It instead means publication within the exchange platform. Since a part of the terms and conditions of participation is confidentiality and non-disclosure, all participants agree to these terms during registration (at 709, FIG. 7A), this is a confidential disclosure. It is not made to the general public or even to non-participants in the arts identified by the domain and subdomain.

In this particular embodiment there are three types or levels of publication. The first is a “public” publication in which the Idea will be visible to all registered experts of the exchange platform whatever their expertise domain is. The Idea Generator will generally select this option if the Idea is basic and they want to verify whether it is making sense. The second is a “domain” publication in which the Idea will be visible only to experts of the same Domain as the one in which the Idea is described. In this particular embodiment, the domain publication is extended to two “connected” domains, which are domains determined a priori to be sufficiently related that experts in those domains may be able to contribute as well. These multi-domain researches will help ensure that no experts will miss the opportunity to contribute to a good idea. The third is a “not visible” publication in which the Idea will not be posted and will not be visible by any Expert of the exchange platform. The Idea Generator will generally select this option if they think the Idea is mature and does not need any changes and improvements. This will result in a direct submission to a registered expert as described further below.

The available types and levels of publication may vary across various embodiments. For example, all of the options described immediately above limit dissemination to registered users of the exchange platform. However, some embodiments may actually include an option to publish to the general public—i.e., beyond the registered users of the exchange platform. This might be useful to, for example, entice unregistered experts to join the exchange platform. Other variations may also occur to those skilled in the art having the benefit of this disclosure. For example, perhaps selected details might be given publication to the general public with the rest revealed once the unregistered expert registers with the exchange platform.

The Idea Generator then determines (at 824) whether it wants to consult a registered expert to evaluate the recommended publication options. If so, an expert is then selected, the expert and the Idea Generator are notified, and a joint selection (at 826) of the publication option is made. The exchange platform will, in this embodiment, create a virtual closed room in which the Idea Generator and the expert may freely communicate details beyond those associated with the Idea at submission. The manner in which the expert is selected will vary among embodiments. For example, some embodiments may employ some kind of matching algorithm predicated on details such as domain, subdomain, keywords, etc. associated with the registered experts and the Idea. In the illustrated embodiment, one or more employees of the entity operating the Exchange Platform 503 make the selection from among the registered experts based on domain expertise and analysis skills. If the Idea. Generator decides against consulting an expert (at 824), then a sole selection of the publication options is made (at 828).

Once the publication option is decided (at 826, 828), the Idea Generator is presented (at 830) with the Transaction/Project Terms and Conditions, which include the financial terms of the transaction. If the Idea Generator does not accept them (at 832), then the transaction ends (at 810) and the submitted idea is not accepted. If the Idea Generator accepts them (at 832), then the Idea is “accepted” (at 836) and the Idea Generator receives notification of acceptance.

Turning now to FIG. 8B, upon acceptance, the Idea undergoes an evaluation process to determine whether it is sufficiently valuable to proceed to finalization and marketing. The idea is published as previously selected. The process flow splits at this point depending on whether the Idea undergoes a public publication (at 838), a domain publication (at 840), or no publication at all.

In the event of a public publication (at 838), the Idea is published (at 842) through notification to all registered experts, who can then access the Idea through their dedicated homepage. If the registered user chooses to do so, they can vote (at 844) on the Idea. In this particular embodiment, the vote is strictly binary as to whether the registered expert likes or dislikes the Idea. Alternative embodiments may employ more sophisticated voting schemes. The registered may also choose (at 846) to follow the Idea and the Idea may be added (at 848) to their dedicated homepage for that purpose.

The vote is counted (at 850) and, if the result is positive (at 852) the flow continues as shown in FIG. 8D and described below. In this particular embodiment, a positive vote is one in which the Idea receives greater than 75% “like” votes. Alternative embodiments may employ alternative measures. If the vote is negative, then the Idea is not selected (at 854) and the process ends (at 810). The illustrated embodiment, though not shown, will offer the Idea Generator to modify the Idea and resubmit it.

In the event of a domain publication (at 840), the Idea is published (at 856) to the registered experts of the domain. The illustrated embodiment also publishes the Idea to the registered experts of the two associated domains as described above. The publication for this particular embodiment is through a blog (at 858) for the pertinent domain. Association with a particular domain subscribes a registered expert to the blog for that domain. The idea is posted as a new item on the blog and the subscribed registered experts are notified of its posting.

The Idea Generator and any interested registered experts with access then dialogue about the Idea through the blog, all as active participants. The goal is to clarify and sharpen the Idea, as well to flesh it out where the registered experts perceive a need. The Idea Generator can shape and direct the conversation. Once the Idea. Generator feels that the Idea has been adequately discussed and prepared, they can close (at 860) the discussion of the Idea on the blog.

Close on the blog (at 860) signifies that the Idea is ready for expert evaluation (at 862). When the Idea is closed (at 860) for discussion on the blog, the registered experts associated with the particular domain are notified that the Idea is ready for evaluation. This notification includes an indication of whether the registered expert is eligible to evaluate, and so prompts the exchange platform to determine whether the respective registered expert has reached their maximum number of evaluations (at 864). If they have, and if they are interested in participating in further evaluations, the registered expert may purchase (at 866) additional evaluation opportunities. If they choose not to (at 868), their participation is at an end (at 810).

The idea is then evaluated (at 870) by the interested registered experts. Alternative embodiments may use a binary “like/dislike” or “up/down” vote. The present embodiment uses a more nuanced mechanism predicated on multiple criteria. The criteria may vary by implementation but should reflect considerations influencing successful realization of the opportunity presented by the Idea. Note that realization does not necessarily equate to commercial realization. Altruistic considerations may also drive the decision.

Thus, some criteria may be neutral in a commercial sense. Exemplary of this type of criteria in various implementations is the developmental stage of the Idea, whether it appears to meet is stated objectives, legality, safety, and manufacturing feasibility. Some may be entirely non-commercial, or altruistic, such as benefit to society without regard to profitability. Still others may be entirely commercial. For example, the evaluation may wish to consider market demand, market trend, market size, and potential for market entry/penetration. Factors other than those listed herein may be used in addition to, in lieu of, or to the exclusion of those listed herein.

The illustrated embodiment not only achieves a robustness through the use of multiple criteria to evaluate the Idea, it manifests a dynamism by allowing the registered experts to grade each criterion on a sliding scale. Not all criteria are graded on the same sliding scale, however. Some may be graded on a scale of 0-5, or 0-100. Some might even have scales with negative values.

Some embodiments may also weight the various criteria. This feature may be combined with the scaled ratings mentioned immediately above. For example, criteria with greater ranges, or at least greater magnitude (regardless of range) scores will effectively weight the criteria in a simple summation. Or, embodiments may employ a separate weighting system more adapted to the implementation specific goals.

Once the multi-criteria evaluation (at 870) is completed, the exchange platform then calculates the result (at 872). If the result is negative (at 874), then the Idea is not selected (at 854) and the process ends (at 810). If the result is positive (at 874), as shown in FIG. 8C, registered experts' details are pushed (at 876) to the Idea Generator for those registered experts who evaluated (at 870) the Idea favorably. More particularly, the exchange platform pushes the registered experts' details to the dedicated homepage of the Idea Generator. This permits the Idea Generator to select one or more experts (at 878).

The exchange platform will check (at 880) whether a selected expert is eligible to participate given previous participation and the participation package previously purchased by the registered expert. If not, then the registered expert can purchase (at 882) additional opportunities so that they can participate in this one or end their participation (at 810). If the selected registered expert is eligible (at 880) and accepts (at 884) the selection, they are presented (at 886) with additional confidentiality terms which they may accept or decline (at 888). If no registered expert selected by the Idea Generator accepts (at 888) the confidentiality terms (at 886), the Idea Generator selects (at 878) another registered expert or group of registered experts.

If a selected registered expert accepts (at 888) the confidentiality terms (at 886), then the exchange platform creates closed virtual room in which the Idea Generator and the registered user can hold private discussions (at 890). The closed room is a virtual collaborative space permitting private communications in which details and documents pertaining to the Idea may be thoroughly and freely shared. Once the user accepts (at 884, 888), access to the closed room is available to each through their respective dedicated homepages. The object of the discussion is to improve the Idea to the point at which the Idea Generator feels it is final or near-final form (at 892) and ready for the next step. At that point, the Idea Generator closes the closed virtual room and the registered expert will be notified. As was mentioned above, the offline identities of the Idea Generator and the registered Expert are masked during this interaction to prevent circumvention of the exchange platform.

Turning now to FIG. 8D, at this point the Idea Generator may repartition the shares (at 894). This involves the Idea Generator will evaluate the contribution of each domain expert into the improvement phase in the closed room and will decide a new share repartition amongst himself and each domain expert. The domain experts are informed of the percentage shares allocated to them by the Idea. Generator, the new share allocation is stored, and the new allocation is listed on the dedicated homepage 610 of each concerned domain expert.

The idea is then evaluated (at 896) by an expert associated with the exchange platform or the entity running it, as opposed to a registered expert. In the event that the selected publication for the Idea is not a public publication (at 838, FIG. 8A) or a domain publication (at 840, FIG. 8A)—that is, if there is no publication—then the process flow jumps to this point as well. The idea is preferably acceptable (at 898) to the exchange expert. If not, the Idea undergoes further modification (at 8100) until the exchange expert is satisfied (at 898) or the Idea is not selected (at 854) and the process ends (at 810) for this idea. The modification (at 8100) occurs in a virtual closed room and with the assistance of the exchange expert.

Once acceptable to the exchange expert (at 898), if the Idea is previously determined to be a simple idea (at 8102), then the Idea is selected (at 8104) to move to the next stage. If the Idea is not simple (at 8102), then it is reviewed (at 8108) by an advisory board drawn up (at 8110) by the exchange platform. The advisory board's deliberations occur in another virtual closed room. If the advisory board's evaluation is positive (at 8112), then the Idea is selected (at 8104). If the advisory board's evaluation is negative (at 8112) then the Idea is returned for modification (at 8100). Note that whether the Idea is simple (at 8102) may be a subjective determination on the part of the exchange expert in some embodiments.

Turning now to FIG. 8E, once the Idea is selected (at 8104, FIG. 8D), there is an opportunity for “preemption” (at 8106). The Idea goes into a list of “preemption eligible” Ideas on the homepage of each Registered User. The preemption can be by any Registered. User selecting the Idea in the list of Idea eligible for preemption. Preemption will be discussed further below. If the Idea is in fact preempted and the Registered User who preempted chooses, the idea realization may then be ended (at 810). If the Idea is preempted and the preempting Registered User nevertheless chooses to continue (at 8108), or if preemption does not take place (at 8110), or if there is no preemption (at 8106), the exchange platform 505 initiates a patent deposit (at 8113).

Initiation of the patent deposit (at 8113) triggers the Exchange Platform 503 to notify a third party that there is a new Idea that is ready for the preparation of a patent application. This third party is typically a patent practitioner who has contracted with the operator of the Exchange Platform 503 for this purpose. This third party notifies the Exchange Platform 503 of their fees for this service related to this particular Idea. If the Idea Generator does not pay (at 8114) this fee, it will be deducted from future profits (at 8116) and the patent application is prepared (at 8118) and, if the file is comprehensive enough (at 8122) to prepare a complete application, filed (at 8123).

As mentioned immediately above, an evaluation is made (at 8122) as to whether there is enough information to properly prepare and complete a patent application. The information and detail gathered on the Idea is forwarded to the Expert to determine (at 8122) whether the file is complete enough, or comprehensive enough, for the patenting process. if not, as shown in FIG. 8F, the Expert and the Idea Generator collaborate (at 8124) to generate and/or acquire the missing information. This may include, for example, reopening the virtual closed room in which they previously collaborated. This may also include an elaboration (at 8126) of the requirements associated with the Idea. If all this can be provided (at 8128) by the Idea Generator and the Expert, it then is (at 8130). If the information is sufficient (at 8132) and the acquisition of information is done, then the Exchange Platform 503 returns to the application process (at 8118, FIG. 8E). If it is insufficient (at 8132), then the Idea process ends (at 810).

If neither the Idea Generator nor the Expert can provide (at 8128) the lacking information, then the Exchange Platform 503 contacts (at 8134) an exchange partner to provide this information. The exchange partner is a third party who has contracted with the Exchange Platform 503 for this purpose. If the idea Generator does not pay the exchange partner's fee (at 8136), then the fee is deducted from future profits (at 8138).

Turning now to FIG. 8G, there is another opportunity for preemption (at 8138), which proceeds as previously described. If there is no preemption (at 8138, 8140), the Exchange Platform 503 considers (at 8142) whether a prototype is to be constructed. If a prototype is to be constructed, it may be by the Idea Generator (at 8144) or by an exchange partner (at 8146). The exchange partner is a third party contracted to the operator of the Exchange Platform 503 for this purpose. If the prototype is generated by the exchange partner (at 8146), then the shares are repartitioned (at 8148). If there is no prototype (at 8142), or once the prototype has been generated by the Idea Generator (at 8144) or the Exchange Partner (at 8146), then the Idea is ready for marketing.

As shown in FIG. 8H, marketing begins with another opportunity for preemption (at 8148) which proceeds as described above. If there is no preemption (at 8148, 8150), the Exchange Platform 503 then begins identifying idea selling options (at 8152). In this particular embodiment, there are essentially two types of selling fixed price and at auction. Note that the Idea Generator can only sell their interest in the Idea. If they own the entire interest, the can sell the entire idea, but if they have repartitioned shares then they can only sell their undivided interest. Other embodiments may handle these facets differently, though.

If the Idea Generator is to sell at a fixed price (at 8154), they enter the fixed price (at 8156) and if the Idea is a simple one (at 8158) in the estimation of the Exchange Platform 503, then the Idea is sold through the “classic sell” (at 8160). In the “classic sell” (at 8160), the Idea Generator's share of the Idea is sold for at the fixed priced previously set (at 8156). If an offer is received (at 8162) then the deal is struck (at 8164, FIG. 8I). After accounting for fees whose payments were previously delayed, the shareholders are paid (at 8166). The parties then rate (at 8168) their experience and the people they worked with and the idea realization process ends (at 810).

Returning to FIG. 8H, if the Idea is not to be sold for a fixed price (at 8154) and it is a simple idea (at 8158), then it nevertheless undergoes the “classic sell” (at 8160) as described immediately above. If, however, it is not a “simple” idea (at 8158), then it undergoes the auction process (at 8170). In this particular embodiment, all registered users of the Exchange Platform 503 are eligible to participate and it is accessible from their respective homepages. The Idea Generator may impose a reserve. The auction remains open for a set period of time, although alternative embodiments may use flexible windows. For example, the window may remain open for a set number of days after the last bid.

If at the close of the auction an offer has been received (at 8172), then, as shown in FIG. 8I, the deal is struck (at 8164). After accounting for fees whose payments were previously delayed, the shareholders are paid (at 8166). The parties then rate (at 8168) their experience and the people they worked with and the idea realization process ends (at 810). However, returning to FIG. 8H, if no offer is received (at 8172), then the Idea Generator is asked (at 8174) to reduce the reserve price. If the Idea Generator agrees (at 8176), then the fixed price is reduced and the auction process begins anew (at 8170). If the Idea Generator disagrees (at 8176), then it falls to the Exchange to consider (at 8178) whether to purchase as discussed further below.

If the Idea Generator refuses (at 8716), then the operator of the Exchange Platform 503 will consider (at 8178) whether to make an offer to buy as shown in FIG. 8I. If the operator makes an offer (at 8180), and the Idea Generator accepts it (at 8182), the deal is struck (at 8164). After accounting for fees whose payments were previously delayed, the shareholders are paid (at 8166). The parties then rate (at 8168) their experience and the people they worked with and the idea realization process ends (at 810). If the operator declines (at 8178) to make an offer or if the Idea Generator declines (at 8182) to accept an offer (at 8180), then the Idea Generator is left to in possession (at 8182) and the process of realizing the business opportunity represented by the Idea ends (at 810).

Returning now to FIG. 6, a registered user may instead, or may additionally, present a problem (at 620) for resolution. In this aspect of the operation for the Exchange Platform 503, the Service Requestor is referred to as the “Problem Owner” since they are providing a problem for resolution. Note that, in this embodiment, the Problem Owner may be an entity rather than an individual. The Service Provider is still referred to as an “Expert”.

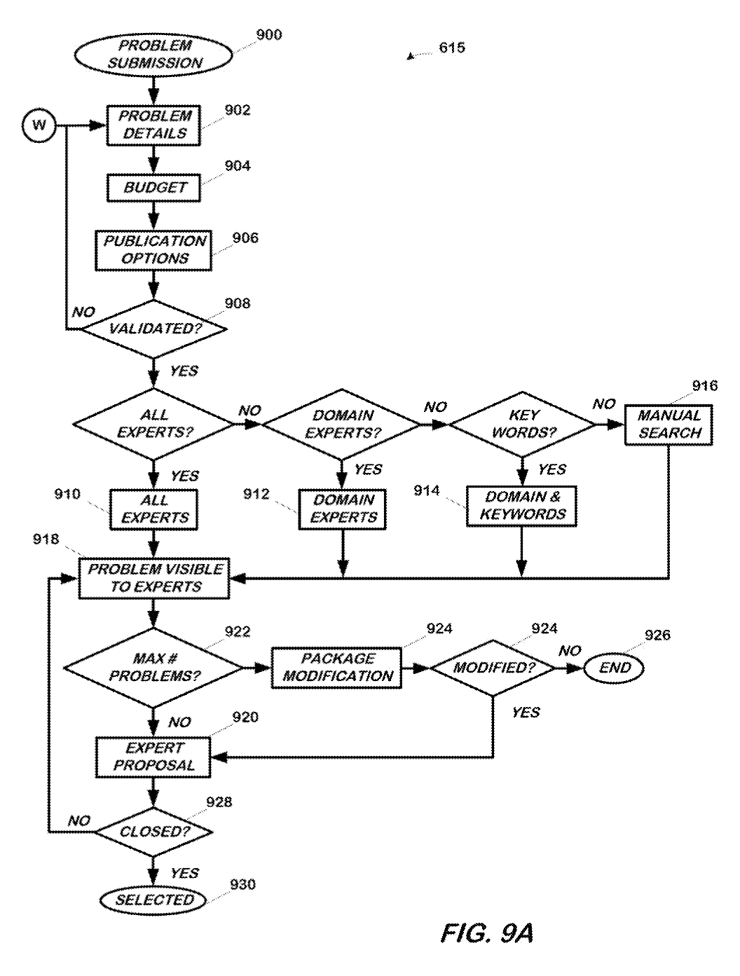

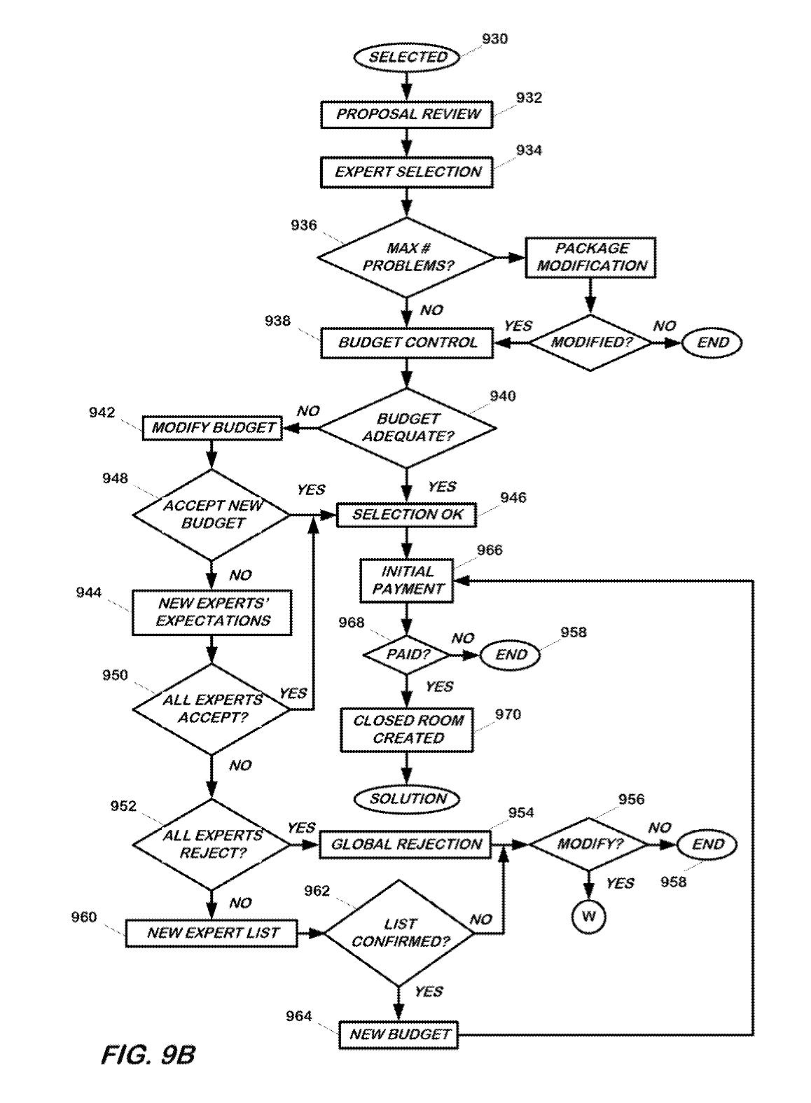

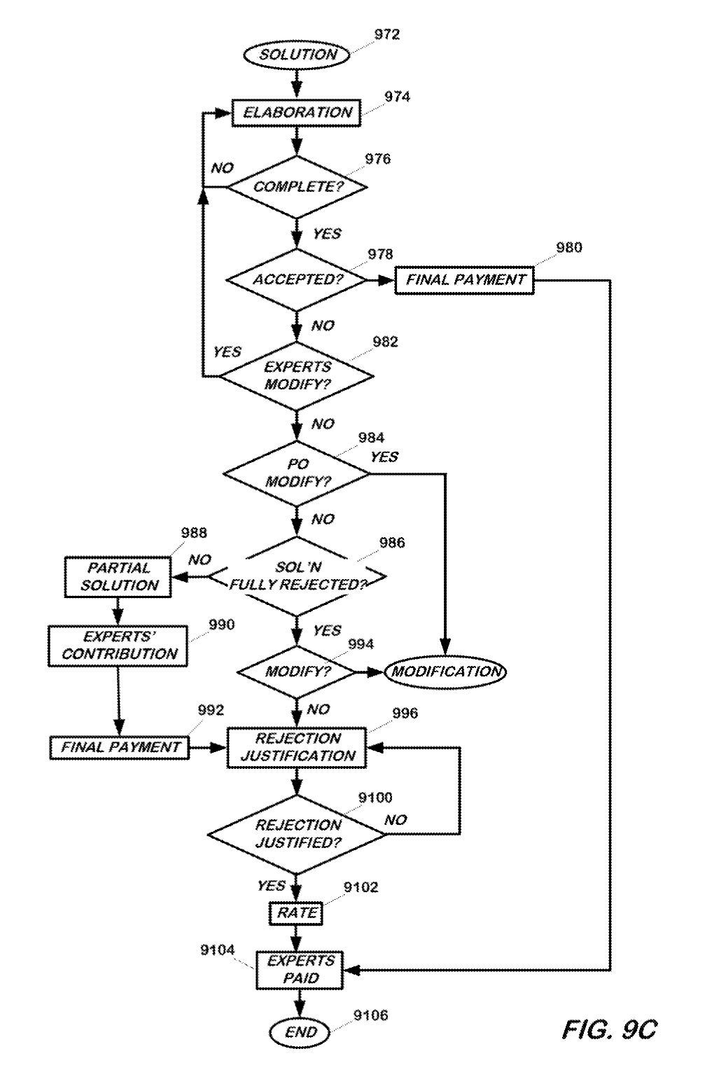

Turning now to FIG. 9A, the process begins with the submission (at 900) of the Problem. The submission typically involves detailing the problem (at 902), setting a budget (at 904) for the process, choosing publication options (at 906), and validation (at 908). If the disclosure does not pass validation (at 908), the Problem Owner is then provided an opportunity (at 908) to further define the problem.

The considerations in the problem detail (at 902) and the publication options (at 906) are much the same as they are in idea submission discussed above. The objective in detailing the problem (at 902) is to provide a sufficiently definite explanation of the problem that it can be resolved through the Exchange Platform 503. The disclosure may be by form entered prose, uploaded documents, etc. The publication options (at 906) similarly can be to all Experts (at 910), Domain Experts (at 912), based on key words (at 914), or on a manual search (at 916) as described above.

The budget (at 904) differs, however. The Problem Owner enters an amount that they are willing to pay to see the problem resolved. In this particular embodiment, the budget also includes the margin that the Platform Exchange 504 will charge for the problem resolution. The remainder of the budget will then be shared by the Experts who participate in the problem resolution.

Once the problem is validated (at 908) and published (at 918) to the appropriate Experts, the Expert may submit (at 920) a proposal to work on the problem. The proposal includes, in this particular embodiment, a description of the solution, the methodology by which it will be implemented, a justification of the methodology, the date of delivery, and the cost. If the Expert has exceeded (at 922) their maximum number of problems for which they have paid, they may modify their package (at 924) and then submit (at 922) a proposal. If the Expert refuses to modify the package (at 924) then their participation ends (at 926).

The Problem Owner may provide a window during which various Experts may submit proposals (at 920) until the window closes (at 928). If a proposal is submitted, then the problem is considered “selected” (at 930). Note that more than one Expert may submit a proposal and that the Problem Owner may select one from amongst several proposals or more than one.

Turning now to FIG. 9B, the Problem Owner then reviews (at 932) the one or more proposals. The Problem Owner reviews the Expert's proposal details as well as Expert Experience and rating. The Problem Owner cannot see the Expert's personal details (Name, Email, Mobile) or the cost entered by Expert. This ensures that Expert selection is driven by the proposal and experience of the Expert, so the Problem Owner can choose the more adequate proposal.

The Problem Owner then selects (at 934) a proposal and, hence, an Expert with which to work. Expert selection (at 934) provides another opportunity for package modification (at 936) before proceeding to budget control (at 938). The Exchange Platform 503 calculates the sum of selected proposals and adds in the margin to get the total proposal cost. It then verifies that the Problem Budget is equal or greater than total proposal cost. If the budget is inadequate (at 940), then either the Problem Owner increases the budget (at 942) or the Expert(s) reduce (at 944) the costs of the proposal. If either of these events successfully occurs, then the proposal selection is confirmed. (at 946).

If (at 948) the Problem Owner does not modify the budget (at 942) and not all of the Experts reduce (at 950) their costs, the Exchange Platform 503 determines whether the Experts' refusal (at 952) is unanimous. If it is, this is considered a “global rejection” (at 954) and the Problem owner is given an opportunity to modify (at 956) the problem and the process returns to modify the provided details (at 902). If the problem owner refuses, then the problem submission ends (at 958). If the refusal (at 950) is not unanimous (at 952), then a new list of Experts is drawn up (at 960). If the list is accepted (at 962), then a new budget is proposed (at 964) and the flow proceeds to payment. If the new list is rejected (at 962), then the Problem Owner is offered (at 956) the opportunity to modify the problem. Again, if the problem owner refuses, then the problem submission ends (at 958).

If a new budget is proposed (at 964) or once the selection is approved (at 946), the flow proceeds to initial payment (at 966). In this particular embodiment, the initial payment is 50% of the agreed upon budget. Failure to pay (at 968) terminates the problem submission (at 958). Once the initial payment is made, the Exchange Platform 503 creates (at 970) a virtual closed room in which the Problem Owner and the Expert(s) may collaborate in private. The virtual closed room includes the Problem Details and documents, a dedicated forum, document management and editing capabilities, etc. The Platform Exchange 503 will verify that anonymous policy is respected so that no names, Email addresses, phone numbers, or other contact information are exchanged between Closed Room members.

Turning now to FIG. 9C, the collaborative solution process (at 972) begins with an elaboration (at 974) of the proposed solution. This continues (at 976) until done and, if the solution is accepted (at 978) then final payment is made (at 980). If the solution is not accepted (at 978), then the Experts may modify (at 982) the solution whereupon the flow returns to the elaboration (at 974) of the proposed solution. If the Experts choose not to modify (at 982), then the Problem Owner is given the option (at 984) to modify the problem statement (at 902).

If the Problem Owner declines to modify the problem statement at this point (at 984), then they indicate (at 986) whether the solution is fully rejected. If partially rejected or resolved (at 986), then the Problem Owner identifies (at 988) which part is solved, from which it is determined (at 990) what the Experts' contribution is. The Experts then receive their final payment (at 992) for that contribution. This final payment (at 992) is typically prorated as a percentage of resolution for the problem.

If the solution is wholly or partially rejected (at 986) and the problem is not modified (at 994), then the Problem Owner must justify (at 996) the rejection. The evaluation of the justification depends, in this particular embodiment, upon whether the budget for the problem resolution is “high”, “medium”, or “low”. This determination is made at the time the budget is arrived at based on parameters supplied by the exchange platform. If the budget is “low”, then any justification will suffice. If “medium”, then an exchange Expert makes the determination. And, if “high”, then a board of exchange Experts is convened to pass judgment. If they deem it unjustified (at 9100), the Problem Owner must again justify the rejection (at 996). Otherwise, the participants then rate one another (at 9102), the Experts are paid (at 9104) and the problem resolution process ends (at 9106).

Returning to FIG. 6, this particular embodiment includes the ability for certain participants to “preempt” the Idea development process 615 or the problem resolution process 620 through a preemption process 625. The preemption process 625 may be total or partial. Both of these alternatives shall not be discussed beginning with total preemption.

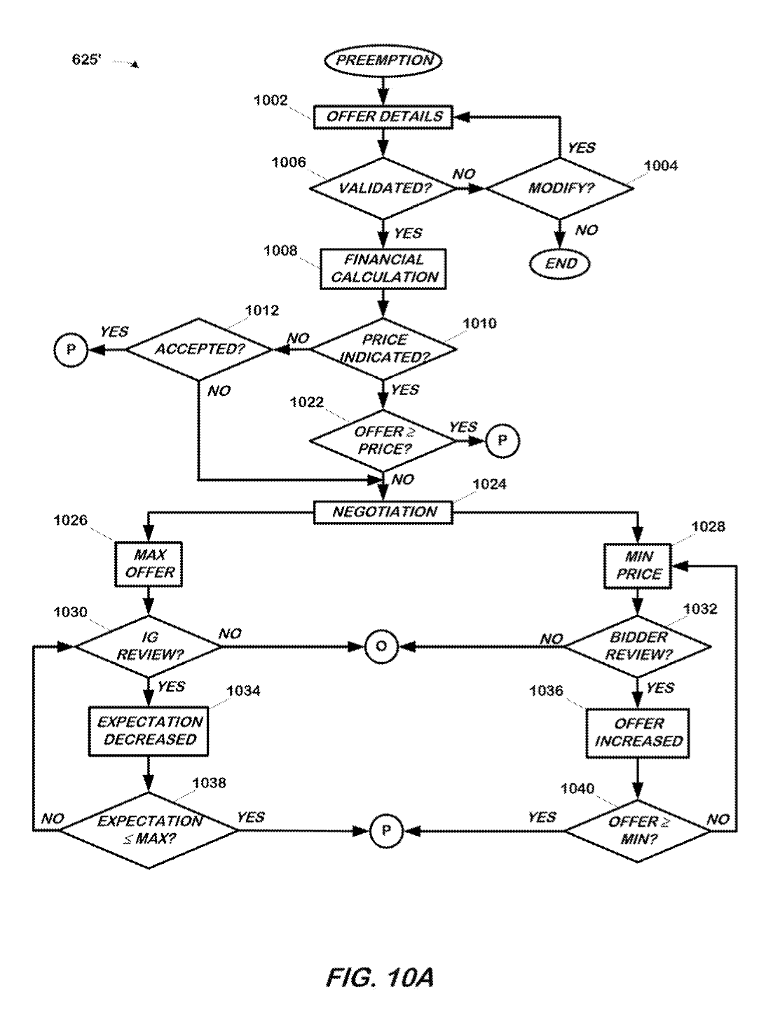

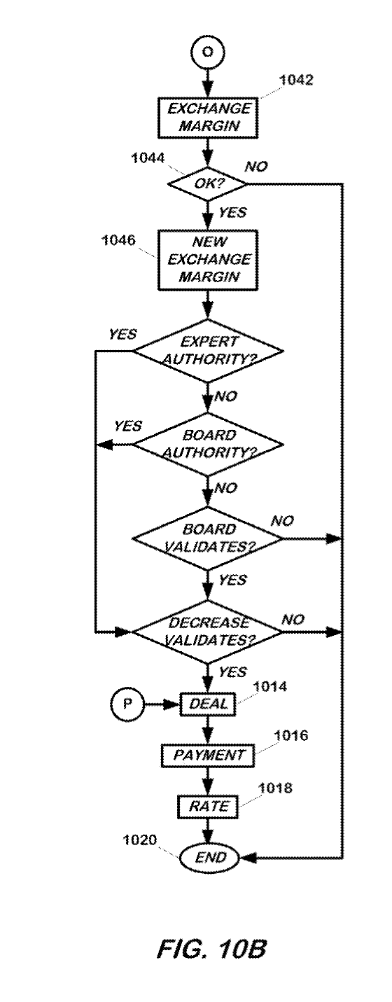

Referring now to FIG. 10A, the first form of preemption is total preemption. This particular embodiment is from a pre-emption in the Ideal development scenario. The person who is attempting to preempt shall be called the “Bidder”, since any Registered User with access to the Idea.

The total preemption process 625′ begins with the Bidder detailing (at 1002) the preemption offer. The Bidder details (at 1002) the offer, sometimes with modification (at 1004) until the offer is validated (at 1006). The offer must include at least an amount, a date through which the offer remains valid, and a reason for the offer for it to be validated (at 1006) in this particular embodiment.

The Exchange Platform 503 then performs (at 1008) a financial calculation based on the amount in the Bidder's offer. The calculation takes the amount and subtracts from it the margin customarily charged by the Exchange Platform 503 to arrive at the offer amount. If the Idea Generator has not yet indicated a price (at 1010) for the Idea at this point, the offer amount communicated to the Idea Generator. If the Idea Generator accepts it (at 1012), then, referring now to FIG. 10B, the deal is struck (at 1014), payment is made (at 1016), the parties all rate (at 1018) one another, and preemption ends (at 1020).

Returning to FIG. 10A, if the Idea Generator has indicated a price (at 1010), then the offer amount is compared against the indicated price. If the offer amounts is greater than the indicated prices, then, referring again to FIG. 10B, the deal is struck (at 1014), payment is made (at 1016), the parties all rate (at 1018) one another, and preemption ends (at 1020). However, if the offer amount is less than (at 1022) the indicated price, or if the Idea Generator does not accept (at 1012), then the Idea Generator and the Bidder enter a negotiation (at 1024).

The negotiation (at 1024) begins when the Idea Generator is notified that their price is too high and the Bidder is notified that their offer amount is too low. The Bidder then submits (at 1026) their maximum offer price and the Idea Generator submits (at 1028) their minimum offer price. The Idea Generator and the Bidder then review (at 1030, 1032) each other's new numbers, each changing their numbers (at 1034, 1036) until one of them accepts (at 1038, 1040) or one of them refuses to continue (at 1030, 1032).

If someone accepts (at 1038, 1040), then the deal is struck (at 1014), payment is made (at 1016), the parties all rate (at 1018) one another, and preemption ends (at 1020) as shown in FIG. 10B. If someone chooses to discontinue (at 1030, 1032) the negotiation, as is shown in FIG. 10B, then the Exchange Platform 503 can review the Exchange Margin (at 1042) and, to facilitate a deal (at 1044), reduce the margin (at 1046). The exchange platform 503 will then review (at 1046, 1048) whether various parties have the authority to authorize the decrease until it is validated (at 1050, 1052). If the Exchange Margin is decreased (at 1046) enough make the deal work and is validated (at 1050, 1052), then the deal is struck (at 1014), payment is made (at 1016), the parties all rate (at 1018) one another, and preemption ends (at 1020). Otherwise, the preemption process ends (at 1020).

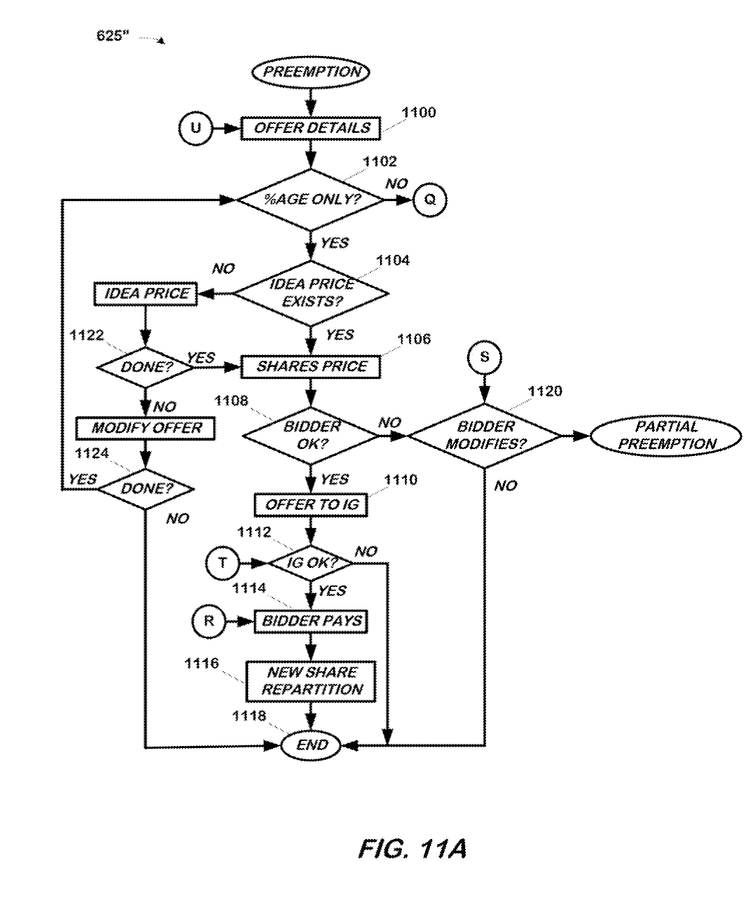

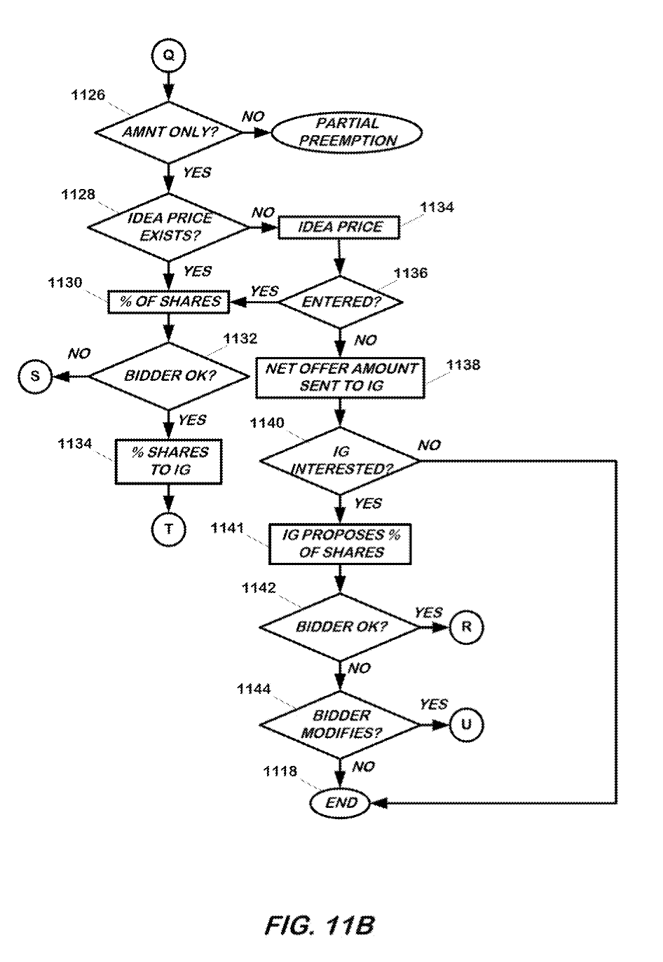

FIG. 11A-FIG. 11B illustrate a first partial preemption 625″. It begins again with details (at 1100) of the Bidder's offer, including amount, window during which it is valid, and reason for the bid. In this particular embodiment, the offer by be expressed as a fixed number or as a value of the percentage of shares they wish to acquire in the Idea. If the Bidder seeks (at 1102) only a percentage of shares and the Idea Generator has indicated (at 1104) at price for the Idea, the Exchange Platform 503 calculates (at 1106) a price for those shares. Upon approval (at 1108) by the bidder, the offer is sent (at 1110) to the Idea Generator. If the Idea Generator accepts (at 1112), then the Bidder pays (at 1114) the agreed upon amount, the shares in the Idea are repartitioned (at 1116), and the preemption ends (at 1118) with a preemption.

If the Idea Generator is sent (at 1110) the offer and declines (at 1112) it, then the preemption process ends (at 1118) with no preemption. If the Bidder does not like (at 1108) the calculate price of the shares they wish to acquire, they have an opportunity to modify (at 1120) the sales price, which will reflect a reduced percentage ownership and the Bidder acquires a partial preemption, the Idea Generator having previously consented. If the Bidder choose not to modify (at 1120), then the preemption process ends (at 1118) with no preemption.

If no Idea Price exists (at 1104), then the Idea Generator is notified. The Idea Generator may choose (at 1122) to enter an Idea Price, and if so, the process continues with the calculation (at 1106) of number of shares for that price. If the Idea Generator chooses (at 1122) not to set an Idea Price, the Bidder may modify (at 1124) their offer. If they do, then the process returns to the specification of the percentage of shares the Bidder would like to acquire (at 1102). If the Bidder declines (at 1122) to modify the offer, then the preemption process ends (at 1118) with no preemption.

Referring now to both FIG. 11A and FIG. 11B, if the Bidder is not seeking (at 1102) to acquire only a percentage ownership of the Idea, then the Bidder indicates (at 1126) whether the offer is for a set amount only as shown in FIG. 11B. If not, then a partial preemption is acquired. If so, then the inquiry turns (at 1128) to whether an Idea Price exists. If so, the Exchange Platform 503 determines (at 1130) the percentage shares the set amount represents. If the Bidder is satisfied with that percentage (at 1132), then the offer as a percentage of shares is transmitted (at 1134) to the Idea Generator. The Idea Generator then determines (at 1112) whether the offer is satisfactory as shown in FIG. 11A and processing continues as previously described. If the Bidder is unsatisfied (at 1132), then they have an opportunity (at 1120) to modify the offer as shown in FIG. 11A and processing continues as previously described.

Referring to FIG. 11B, If the Idea Price does not exist (at 1128) at this point, the Idea Generator may enter (at 1134) one. If (at 1136) an Idea Price is entered, then the Exchange Platform 503 determines (at 1130) the percentage shares that amount represents and processing continues as previously described. If the Idea Generator declines (at 1136) to enter an Idea Price, then a Net Offer Amount (i.e., the amount offered less the Exchange Margin) is transmitted (at 1138) to the Idea Generator. If the Net Offer Amount is sufficient to interest the Idea Generator (at 1140), then the Idea Generator may propose (at 1141) a percentage of shares to the Bidder. If the Bidder accepts (at 1142) the offer, then the Bidder pays (at 1114) as shown in FIG. 11A and processing continues as previously discussed. If the Bidder declines (at 1142) the proposal and wishes to modify the bid (at 1144), then the partial preemption process of FIG. 11A-FIG. 11B restarts (at 1100). If the Bidder declines (at 1142) and does not modify the bid (at 1144), then the preemption process ends (at 1118) with no preemption.

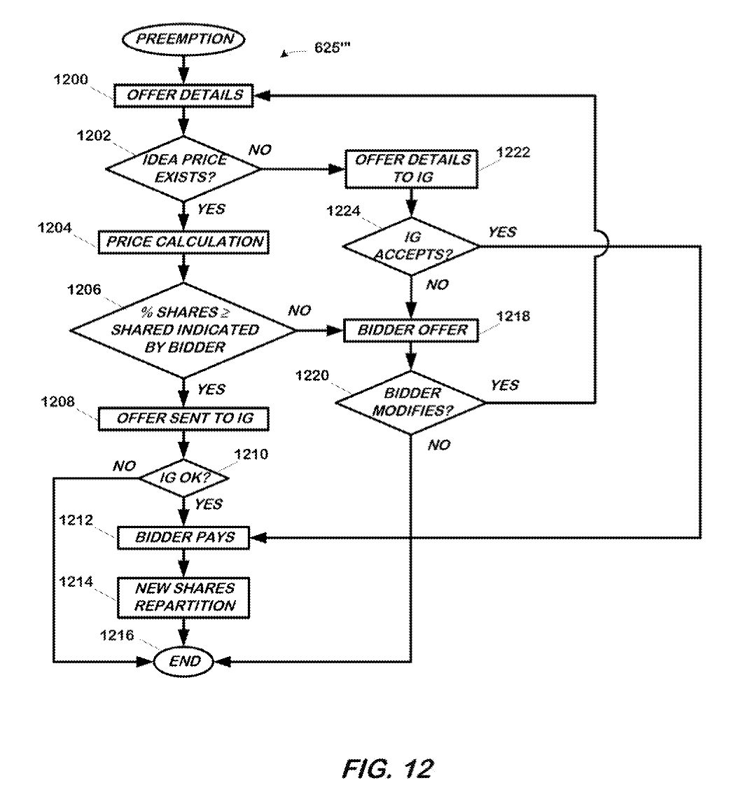

A second partial preemption technique 625′″ is illustrated in FIG. 12. The process begins with the Bidder detailing (at 1200) the offer, including amount, period for the window, and the reason for the offer. If an Idea Price exists (at 1202), then the Exchange Platform 503 determines (at 1204) what percentage of shares that Idea Price represents. If that amount is greater or equal (at 1206) to that desired by the Bidder, the offer is sent (at 1208) to the Idea Generator. If the offer is acceptable (at 1210) to the Idea Generator, then the Bidder pays (at 1212) the offer. The shares are then repartitioned (at 1214) and the preemption process ends (at 1216). If the offer is not acceptable (at 1210), then the preemption process ends (at 1216) without preemption.

If the percentage of shares represented by the Bidder's offer is less than (at 1206) the offer price, then the Bidder is asked to revisit (at 1218) the offer. If the Bidder modifies the offer, then the preemption process restarts. If there is no Price Idea (at 1202) in the first instance, then the details of the offer are sent (at 1222) to the Idea Generator. If the Idea Generator accepts (at 1224), then the Bidder pays (1212), the shares are then repartitioned (at 1214), and the preemption process ends (at 1216). If the Idea Generator declines (at 1224), then the Bidder is asked to revisit (at 1218) the offer and the processing continues as described immediately above.

The phrase “capable of” as used herein is a recognition of the fact that some functions described for the various parts of the disclosed apparatus are performed only when the apparatus is powered and/or in operation. Those in the art having the benefit of this disclosure will appreciate that the embodiments illustrated herein include a number of electronic or electro-mechanical parts that, to operate, require electrical power. Even when provided with power, some functions described herein only occur when in operation. Thus, at times, some embodiments of the apparatus of the invention are “capable of” performing the recited functions even when they are not actually performing them—i.e., when there is no power, or when they are powered but not in operation, or when in operation but not at an appropriate point for a certain functionality to be executed.

Where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A computer-implemented method for crowd sourced realization of a business opportunity, comprising:
facilitating an online discussion of the business opportunity between a registered service requestor and a first registered service provider;
receiving a presentation of the business opportunity;
evaluating the received business opportunity for realization relative to a plurality of registered service providers;
assigning the evaluated business opportunity to at least one of the registered service providers pursuant to the outcome of the evaluation;
imposing a pricing system on the presentation, evaluation, and assignment of the business opportunity;
wherein the receiving, evaluating, and assigning are performed by a processor.

2. The method of claim 1, wherein the business opportunity comprises a new product or service or a problem to solve.

3. The method of claim 1, wherein the service providers comprise registered, self-organized service providers.

4. The method of claim 3, further comprising managing the self-organization of the registered service providers.

5. The method of claim 4, wherein managing the self-organization occurs at the time of enlistment.

6. The method of claim 4, wherein managing the self-organization occurs at a time subsequent to enlistment.

7. The method of claim 1, wherein the facilitating the online discussion includes hosting a blog or an interactive chat session.

8. The method of claim 1, wherein the plurality of registered service providers includes the first registered service provider.

9. A computing system programmed to perform a method for crowd sourced realization of a business opportunity, the method comprising:
facilitating an online discussion of the business opportunity between a registered service requestor and a first registered service provider;
receiving a presentation of the business opportunity;
evaluating the received business opportunity for realization relative to a plurality of registered service providers;
assigning the evaluated business opportunity to at least one of the registered service providers pursuant to the outcome of the evaluation;
imposing a pricing system on the presentation, evaluation, and assignment of the business opportunity;
wherein the receiving, evaluating, and assigning are performed by a processor.

10. The computing system of claim 9, wherein business opportunity comprises a new product or service or a problem to solve.

11. The computing system of claim 9, wherein the service providers comprise registered, self-organized service providers.

12. The computing system of claim 11, wherein the method further comprises managing the self-organization of the registered service providers.

13. The computing system of claim 12, wherein managing the self-organization occurs at the time of enlistment.

14. The computing system of claim 12, wherein managing the self-organization occurs at a time subsequent to enlistment.

15. The computing system of claim 9, wherein facilitating the online discussion includes hosting a blog or an interactive chat session.

16. The computing system of claim 9, wherein the plurality of registered service providers includes the first registered service provider.

17. A non-transitory program storage medium encoded with instructions that, when executed by a computing apparatus, perform a computer-implemented method for crowd sourced realization of a business opportunity, the method comprising:
facilitating an online discussion of the business opportunity between a registered service requestor and a first registered service provider;
receiving a presentation of the business opportunity;
evaluating the received business opportunity for realization relative to a plurality of registered service providers;
assigning the evaluated business opportunity to at least one of the registered service providers pursuant to the outcome of the evaluation;
imposing a pricing system on the presentation, evaluation, and assignment of the business opportunity;
wherein the receiving, evaluating, and assigning are performed by a processor.

18. The non-transitory program storage medium of claim 17, wherein the business opportunity comprises a new product or service or a problem to solve.

19. The non-transitory program storage medium of claim 17, wherein the service providers comprise registered, self-organized service providers.

20. The non-transitory program storage medium of claim 19, wherein the method further comprises managing the self-organization of the registered service providers.

21. The non-transitory program storage medium of claim 20, wherein managing the self-organization occurs at the time of enlistment.

22. The non-transitory program storage medium of claim 20, wherein managing the self-organization occurs at a time subsequent to enlistment.

23. The non-transitory program storage medium of claim 17, wherein the facilitating the online discussion includes hosting a blog or an interactive chat session.

24. The non-transitory program storage medium of claim 17, wherein the plurality of registered service providers includes the first registered service provider.
